(19) United States
(12) Patent Application Publication
(10) Pub. No.: US 2015/0079579 A1
(43) Pub. Date: Mar. 19, 2015

(54) INTEGRATED PHYSICAL SENSOR GRID AND LESSON SYSTEM

(71) Applicant: Ian James Oliver

(72) Inventors: Ian James Oliver, mawson (AU); Stephen Edward Ecob, Chatswood West (AU)

(21) Appl. No.: 14/484,563

(22) Filed: Sep. 12, 2014

Related U.S. Application Data
(60) Provisional application No. 61/877,747, filed on Sep. 13, 2013.

(51) Int. Cl. G09B 5/08

(52) U.S. Cl. CPC G09B 5/08
USPC 434/362

(57) ABSTRACT

An integrated physical sensor grid system includes a plurality of nodes, a processor, and a computing device. One or more nodes consisting of electrical contacts and one or more sensors to detect electrical properties at each electrical contact are connected to a processor. The computing device is configured to display instructions to a user. The processor and mobile computing measure and compares readings of the one or more sensors against expected values indicated in the lesson plan. The computing device is configured to display results to the user in response to the comparison of readings against expected progress. The lesson plan consists of instructions and expected values to verify. The lesson plan may be shared by access to a database.

### BACKGROUND

The use of computer programs and apps to allow users to learning and experiment using virtual or simulated systems is well known and wide spread. However such learning has limitations. Learning and education theory has established that when learning involves multiple sensory experience including touch and physical interaction with object as opposed to purely virtual learning there is improved understanding, memory and confidence to apply the theory or principal taught. The difference between a theoretical knowledge and the ability and confidence to apply this knowledge to real world problems is bridged by learning which involves the physical world. After learning a theoretical concept, creative play can be used to reinforce learning. Virtual systems are useful for allowing simulated creative manipulation of real world systems.

However interactions involving virtualized input and output mostly cannot capture the complexities of real world, so there is a big gap between the usefulness of virtual learning as opposed to real world learning. The unpredictability of real world systems and hence opportunity to learn and interact in a more realistic manner are significant. In addition to teaching using physical interactions, project based learning where a student or group build and deliver a product which is often physical, is a popular way to teach and develops innovation and creative play. A framework is desirable that allows students to create fun projects where they can share the project including instruction on how to make as well as results, receive reviews and votes and search for projects with physical components they have at hand and also provides an incentive to create. For example, creating a game using programming alone to simulate a pinball machine is educational and will teach the student how to mimic physical responses and systems but a different experience closer to real world activities the user may do in their career would be the creation of physical a pinball machine. Kindergarten aged children benefit from physical play. Students enjoy using smart devices to play games and learn in preference to many traditional styles of learning. Electronic kits have been a popular educational product because they combine learning with the practical creation of circuits that are enjoyable to build. Their popularity has diminished with the growth in smart devices with games consuming kids time and also virtual educational applications. Traditional kit circuits such as moisture sensors, blinking LEDs tend not to engage the new generation.

Traditional circuit wiring kits have an extra depth of problem solving beyond just designing a circuit in the physical construction of circuit and debugging connection mistakes and errors introduced while physical construction. When the child or student and even parent or tutor cannot fix the problem in reasonable time frame then the usefulness of physical construction and interaction is reduced by these complications ultimately rendering such teaching methods unenjoyable, unachievable, or frustrating causing students to abandon or dislike physical circuit and system construction.

A system is needed which will solve these problems, which cause the student to maintain the momentum of the learning process when problems are encountered. Further, the traditional kit and book approach has a new fresh appeal when it is now used on smart devices that allow graphics to be built into the interaction with the user and circuit and the ability to share content and circuits. For testing of different components such as resistance and capacitance, there exist known methods and systems to the field and application of in-circuit testing employing techniques including AC and DC voltages and currents. To measure an unknown resistance current from a known constant current source is applied and then the voltage measured using ADC from which using ohms law the resistance can be calculated. For AC voltage measurement it is rectified to convert it into proportional DC voltage and sampled with an ADC. To measure AC and DC currents, the current is converted proportionally into voltage with an I-V converter and sampled with an ADC. DC voltage can be read with the ADC.

Various methods are available for the measurement of capacitance by measurement of the time constant of charge or discharge through a known resistor. Diodes can be tested for large resistances in the Mega Ohm in one direction and small resistance in other direction; transistors can be measured in a similar manner. Zener diodes have varying voltage drops according to their rating when and Led general have a voltage drop between 1.5 to 2.5 volts. You can think of a transistor as two back-to-back diodes in one package and test accordingly. Many other components can be tested in different combination of these and similar techniques well known in the field of in circuit testing.

### SUMMARY

Embodiments of a system are described. In one embodiment, the system is a sensor grid system that receives inputs and produces outputs according to a lesson plan comprising of teaching content with integrated physical checking content which may be downloaded from other users or shared to other users. The system includes a grid with two or more nodes up to an unlimited number that can receive or output electrical signals. Each node may have outputs sent to it including a power supply or Digital to Analogue Converter DAC applied to it. This system seeks to combine the educational value of physical skills and play combined with education that activates such as electronic kits provide with the engagement of games and apps on smart devices that students have become accustomed to. Traditional electronics kits provide a grid where components can be placed to make a circuit. A power supply usually a battery is needed to power the circuit. A Multimeter to measure voltage, current and resistance is also required. The system seeks to create an intelligent system that can detect circuits constructed on the grid and verify if they are correct or not. When students are following instructions to create a circuit it can help to verify if they have wired it correctly. If a resistor is placed on the grid it will detect that the resistor is between the two nodes or terminals by passing a test current through it to measure the resistance. In one example, If a circuit with a +5 v supplied to a node, a resistor from that node to a second node and another resistor to a third node to which the 0 v connection has been supplied then the system will detect the nodes with voltage +5 v, 0 v and the middle node with 2.5 v if the two resistors are of equal value. The system can also measure the current through the power supply and from this estimate the values of types of the components. To analyze components such as capacitors, inductors and semiconductors as a few non limiting examples, DC and AC voltages may be passed through the nodes as measuring values. Methods on the use of in-circuit and general component testing will be well known to persons skilled in the art.

In one embodiment for engaging educational learning, a student is instructed by a grid sensor lesson comprising of text, video, Image and audible content that is presented in concert with an interactive Smart device User Interface, to connect a described circuit to exact node numbers. To give feed back and assistance with mistakes as the lesson and construction progresses the circuit is checked using circuit verification profile which is part of the lesson unit. The circuit verification profile will include the expected values that should be found at each of these nodes. The system shall check all the nodes by switching the multiplexers between each node and between the required measuring ADC, digital GPIO or DAC or power supply. When the measured and expected values do not correspond the student is asked to check the circuit with hints available as the application is aware of the node values where the mistake is. The expected values can be stored in configuration tables as shown in FIG. 8 and FIG. 9 where the values may have been generated in a number of ways including firstly, by sampling the nodes of the circuit after it has been physically constructed on the sensor grid and storing values for all nodes discovered. In this recording mode the use of the circuit in the various modes “component”, “static”, “dynamic” provides enough information to automatically generate the verification information Secondly, the user directly enters values and ranges as well as typical ranges and types. Thirdly, circuit schematic described in the lesson can be used to generate definition file using circuit simulation software from which not only can a display to the user be created but also a configuration of values to check as shown in FIG. 8 and FIG. 9. Fourthly, code can be generated by the user to configure the multiplexers and sampling components such as the ADC, DAC, power supply and Digital IO in order to check the circuit. The code would specify which nodes to check and what input to places through the nodes and check voltages and currents produced. As more people use the same circuit design using statistical methods the range of acceptable values may be adjusted for the same circuit for all users who build the same circuit and obtain the same results. The grid sensor lesson contain a circuit verification profile. The labels Node “A”, Node “B”, etc. can be used to allow the user to know to which nodes to connect components. If exact nodes are not specified or to where the circuit has been connect in a different location, where it may have been correctly wired but just to the wrong nodes, extra logic analysis software to try to discover the nodes used for the circuit by using the expected values. This ability to check dynamically allows the system to automatically check the circuit and progress the next step or provide remedial step. It also makes the progression of learning steps more spontaneous. The student is not required to measure any nodes manually although this can be done also if desired. If the multiplexers are switched quickly, then all the node values can be viewed simultaneously. In one example, the student may be first introduced through the lesson content to teaching about resistance calculation for series electronics circuits. The student be may given physical resistors with only the color codes as a means of identification and be prompted to place a two 1 k resistors in parallel on a 5 volt supply and find that the voltage over each of the 1 k resistors is 2.5 v. After the color labeling codes and circuit theory has been taught then to reinforce the teaching points the practice of placing different resistor combinations together to obtain different voltages across the resistors can be reinforced by the application entering into an educational consolidation phase where the student must complete a time trial or progress based game where the smart device asks the user to wire circuits with varying voltages an the game progressing when the measurement system senses the correct values have been physically placed on the board. In this manner a game could be made to cover all the facets of the course each with such a gamefied testing phases with the successfully completion of the course being the completion of the game. If the student has designed their own circuit and supplied input and output specifications that it is to be achieved, the invention can make suggestions for improvement. Traditional kit circuits such as moisture sensors, blinking LEDs tend not to engage the new generation. An advantage of a system hosting the electronic measurement system on a smart device is that as electronic connection nodes are connected to the system, these nodes can also be used as not only measurement points but as input and output points into a smart device display. This means that students can make lessons including defining circuits to be constructed in the grid that are based around fresh virtual scenarios involving real world electronics and real world physical sensing combined with displays on smart device displays. A central aspect of this system is that users such as teachers or other students can create educational lesson material linked with example circuits where the circuit construction is described, or description of a problem to solve where the student has to supply a circuit. These circuit lessons can be share thru a server between users. In this way a system can be capable of supporting potentially large number of educational circuits supported by a community of contributors resulting in one embodiment as crowd sourcing of circuit experiments and lessons. Some circuits lessons require only circuit to be made which is self contained having it's own electronic inputs and outputs for example a switch that closes a circuit with a battery and siren. Other circuit lessons such as an amplifier circuit may work best with an input from a signal generator controlled on the smart device. As well as the system having the ability to measure and inject signals at the nodes. The measurement may also be performed manually by way of a measurement display on the smart device as well as signal outputs that can be connected to nodes 118, 119 in a similar manner to as if external test equipment is used by a user to probe different nodes on a circuit to fault find a circuit.

In one mode, the multiplexers can switch between all nodes in real time and show simultaneous values for voltages and currents.

The ability for anyone to share a circuit, some instructions on how to make it as well as some theory and a way to help the user debug the circuit step by step makes creation of circuits and other real world system possible even if there is no skilled person to assist the student whom may be making the circuit at home with parents who are also not skilled or even a teacher with little or no skills. In addition to electronic circuits, all forms of physical sensing systems can be created and checked using the grid sensor lesson and circuit verification profile.

### BRIEF DESCRIPTION OF THE DRAWINGS

FIG. 1 depicts one embodiment of a system comprising of a sensor grid that receives inputs and produces outputs according to a lesson plan comprising of teaching content with integrated physical checking content which may be downloaded from other users or shared to other users. The system can check a node to see if the correct components are connected. To achieve this, some combination of ADC 109 and DAC 110 as well as digital Input Output 125 and fixed or variable power supplies 108 are applied to node(s) in order to test a component. In this way the user will be able to view the complete analysis and response of a component on the display of the mobile computing device and be able to interact with the variation of stimuli for measurement as well as view graphs. The application of ADC 109 and DAC 110 as well as digital Input Output 125 and power supplies 108 is used to apply voltages and currents of varying magnitudes to the node(s) connected to the component and measurement of the various voltage, current and time responses in order to measure resistance, capacitance, inductance and semi conductor properties as some non limiting character as well known to the field of in circuit testing of components and overall circuit measurement. One component can be measured in isolation if its other side is connected to ground.

Additionally a second function of the system is to check the voltages and currents at nodes to see if they respond in a “static” state when no external stimulus is applied which may be useful to confirm that the circuit is wired correctly based on voltages and currents at set points. A check can also be done of the “dynamic” response of the system when stimuli is applied or the system is otherwise allowed to function and generate responses. The circuit can be verified to be wired correctly based on voltages and currents at set points when stimuli are applied by the user or other external perhaps synchronized by the issuing of instructions to a user. Alternatively, the signals can be configured to be applied at nodes using the DAC to provide stimulus. The system checks all the nodes by switching the multiplexers between each node and between the required ADC, digital GPIO or DAC or power supply.

FIG. 2 depicts one embodiment of a system comprising of a sensor grid system that receives inputs and produces outputs according to a lesson plan comprising of teaching content with integrated physical checking content which may be downloaded from other users or shared to other users. In this circuit the use of two multiplexers 200,208 and a two pole multiplexer 201 version of 107, allows the measurement of a component by application of variable and constant voltages and currents. The multiplexers function as switch make an electrical connection in various combinations of inputs and outputs. If other components are connected to the circuit depending on the arrangement they may also be measured complicating the measurement of the isolated component value of interest which this configuration overcomes by allowing the selection of the nodes on all sides of the component which can also be combined with techniques in FIG. 10 to completely isolate nodes and pre-nodes for isolated testing of components. The system shall check all the nodes by switching the multiplexers between each node and between the required measuring ADC, digital GPIO or DAC or power supply. This could be extended in the same way to three or simultaneous node measurements.

FIG. 3 depicts one embodiment of a graph showing the increase in pressure inside a balloon as a person blows up a balloon until it pops.

FIG. 4 depicts one embodiment of a circuit with a pressure sensor inside a balloon which is connected in series with a second resistor. The pressure sensor output in this example is 0.5V when atmospheric room temperature and +4.5V at highest. The balloon under full pressure will register a voltage of +4.2V. A +5V power supply is applied at the positive power supply to the pressure sensor with the ground pin connected to 0V. The pressure sensor output is connected to a resistor the other side of which is connected to 0V. The graph shown in FIG. 3 follows the voltage at node C 103.

FIG. 5 depicts one embodiment of a grid sensor lesson comprising of a series of steps and content for each step. During the lesson the circuit verification profile is used to check that the circuit has been wired correctly.

FIG. 6 depicts one embodiment of a puzzle in the form of flashing graphics on a display of a mobile computing device. The user uses this as a clue to construct a logic circuit on the sensor grid that will simulate the pattern that causes the light 604 to flash when the same combination of nodes as shown in the flashing graphics occurs.

FIG. 7 depicts one embodiment of the user's solution to the puzzle, FIG. 6, formed by physically wiring the AND gate inputs to node “B” 102 and node “C” 103 and the output to node “D”.

FIG. 8 depicts one embodiment of a circuit verification profile for the example circuit shown in FIG. 4 which allows the monitoring of node “C” 103 voltage to display the change in pressure as a balloon is expanded.

FIG. 9 depicts one embodiment of a circuit verification profile for the example digital AND gate circuit shown in FIG. 7.

FIG. 10 depicts one embodiment of an alternative wiring method for connection nodes to allow current measurement where up to typically four wires can be joined to a node but instead of joining directly to the node each wire joins to a “pre-node” connection.

FIG. 11 depicts one embodiment of two alternative methods to interact with a lever and fulcrum. According to one method, the lever and fulcrum has sensors that are connected to the grid by connector where the lever, fulcrum and sensors can also be integrated as one unit. According to a second method, the lever and fulcrum has sensors that are connected to multiplexers, ADC, DAC, digital Input/output and processing unit that are all integrated together in one unit which in turn can communicate to the mobile computing device 116 running a lesson.

FIG. 12 depicts one embodiment of an example of a game that can be constructed with the system. The user has the challenge to use the handle to move a loop along a wire without touching a wire. If a wire is touched before reaching the end then a light is turned on as well as optionally a display and or audible buzzer indicating failure to complete the task using the mobile computing device.

Throughout descriptions ADC refers to Analogue to Digital Converter and DAC refers to Digital to Analogue Converter. GPIO refers to General Purpose Input Out. ADC refers to Analogue to Digital Converter and PWM refers to Pulse Width Modulation. API refers to application programming Interface.

### DETAILED DESCRIPTION

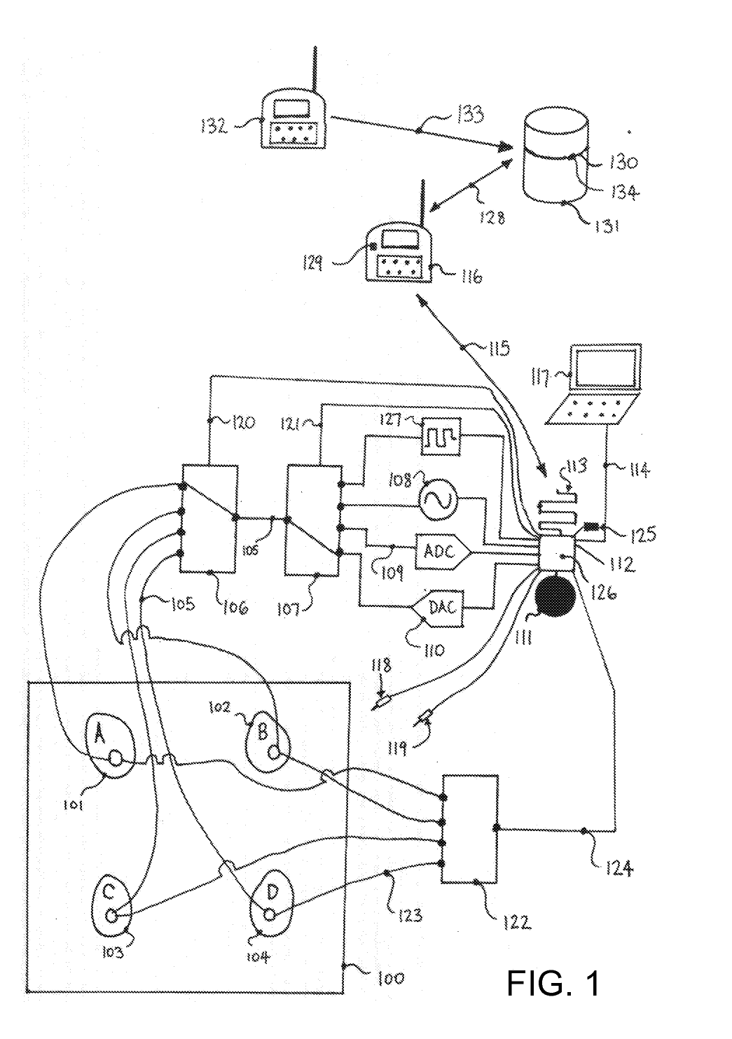

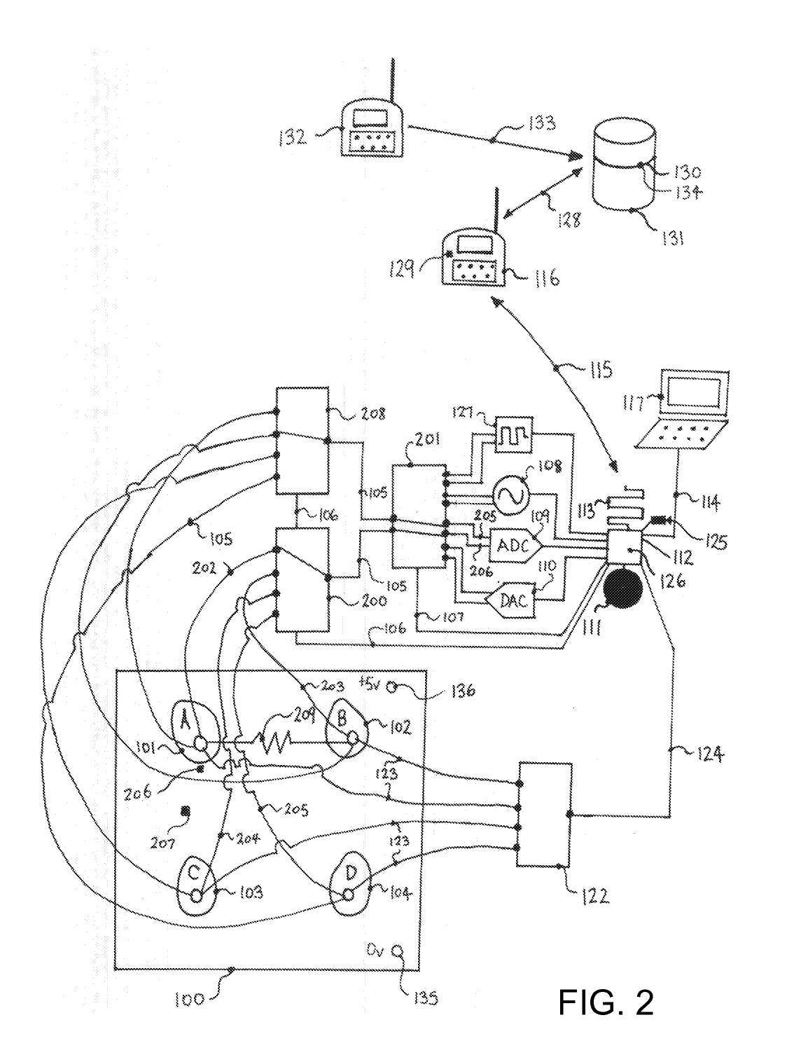

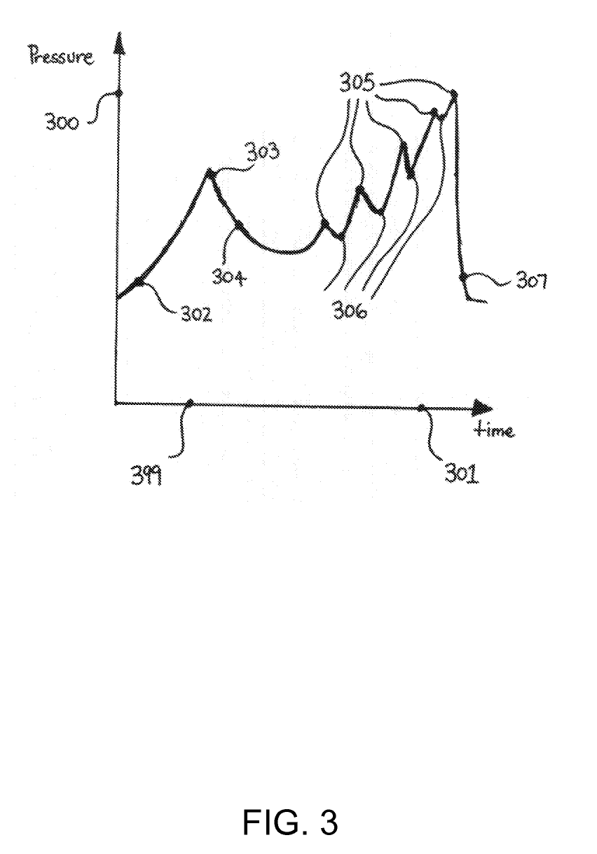

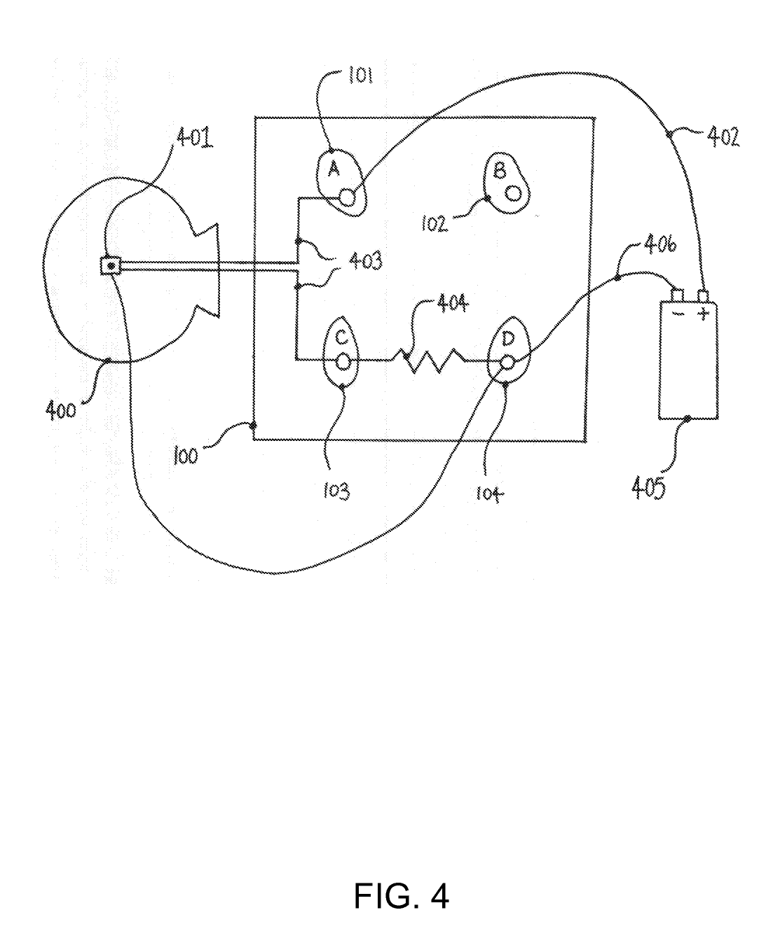

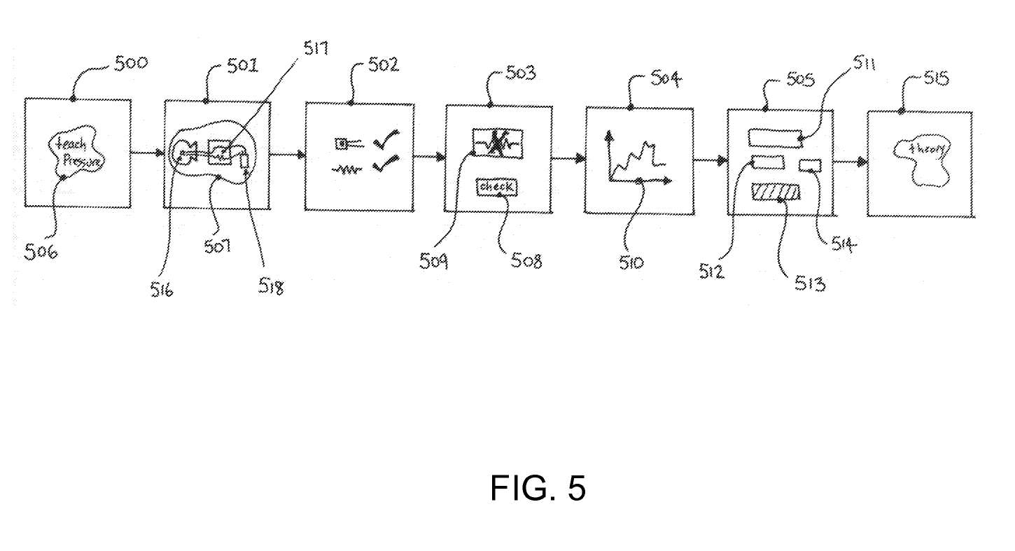

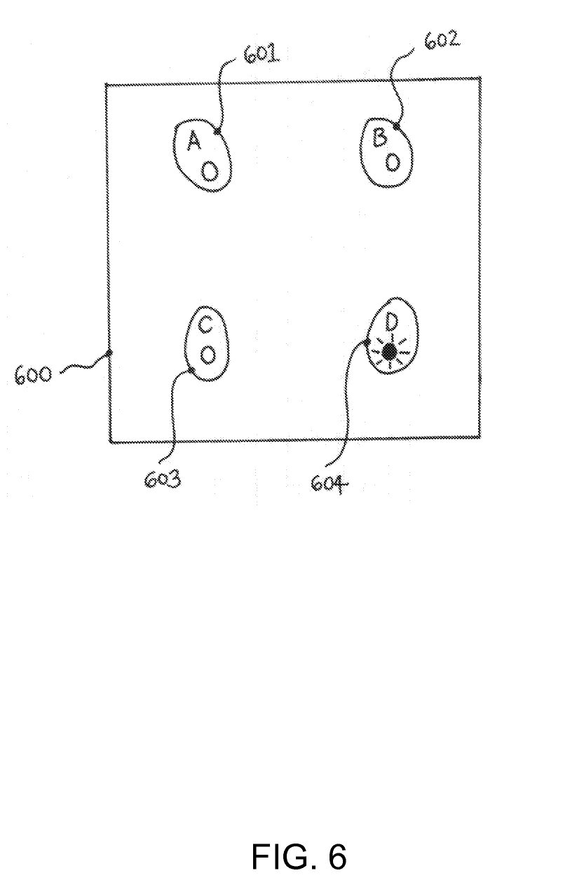

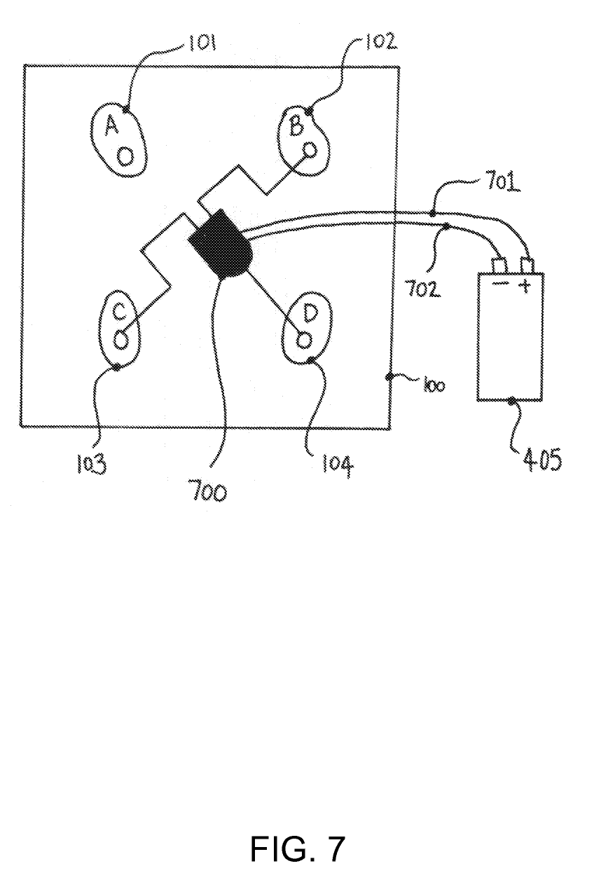

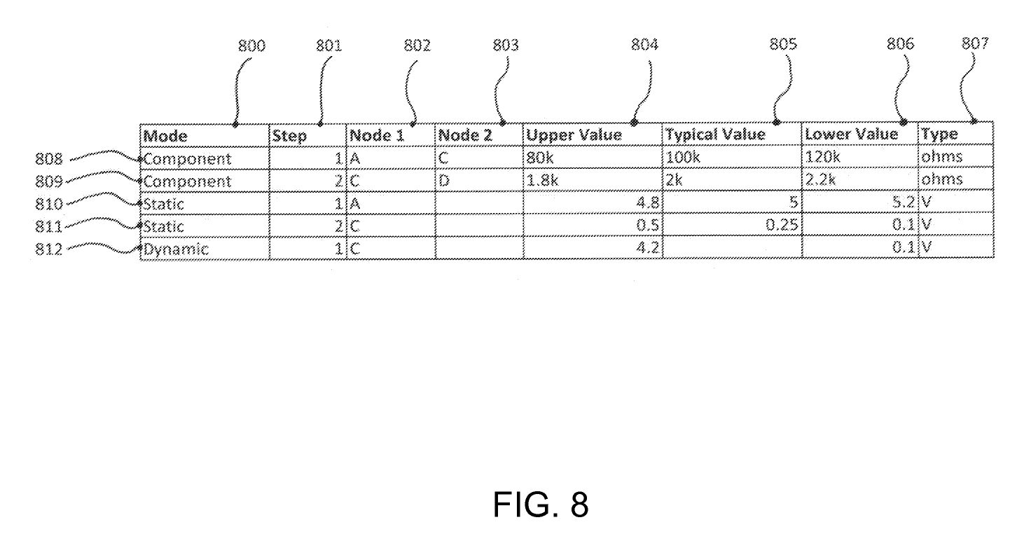

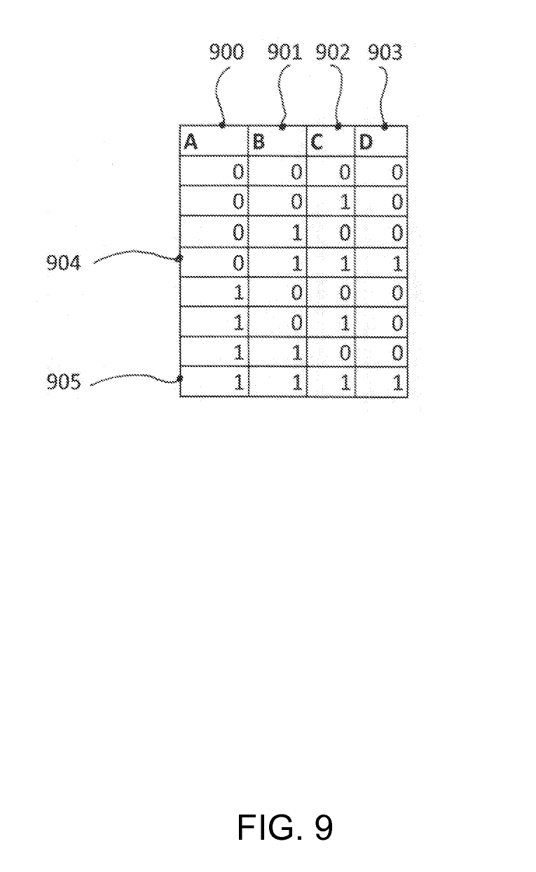

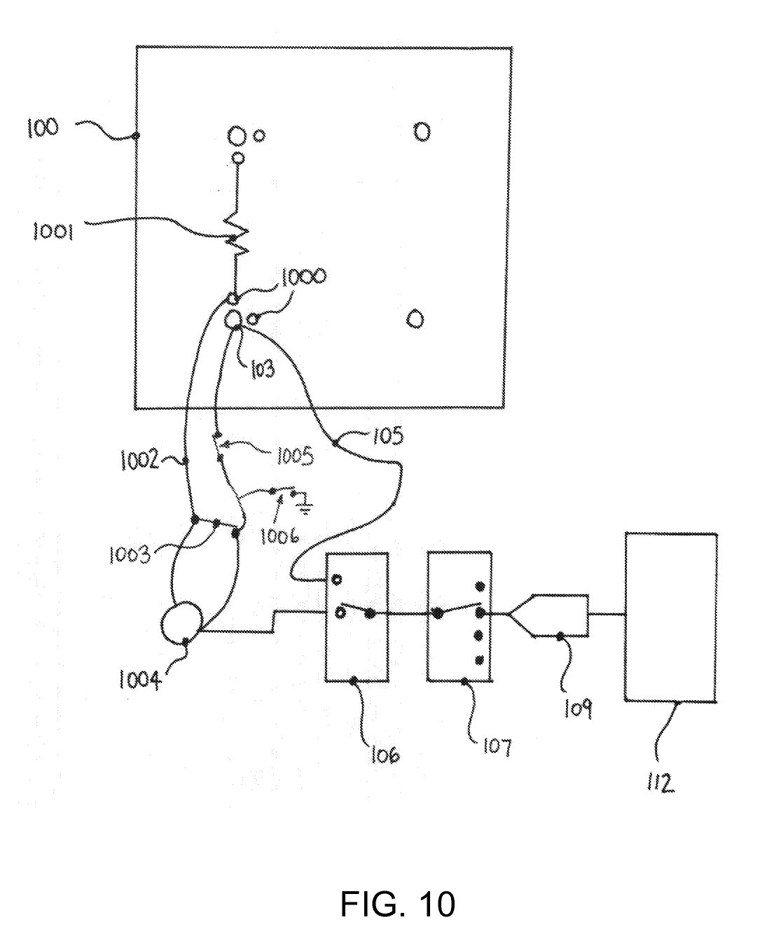

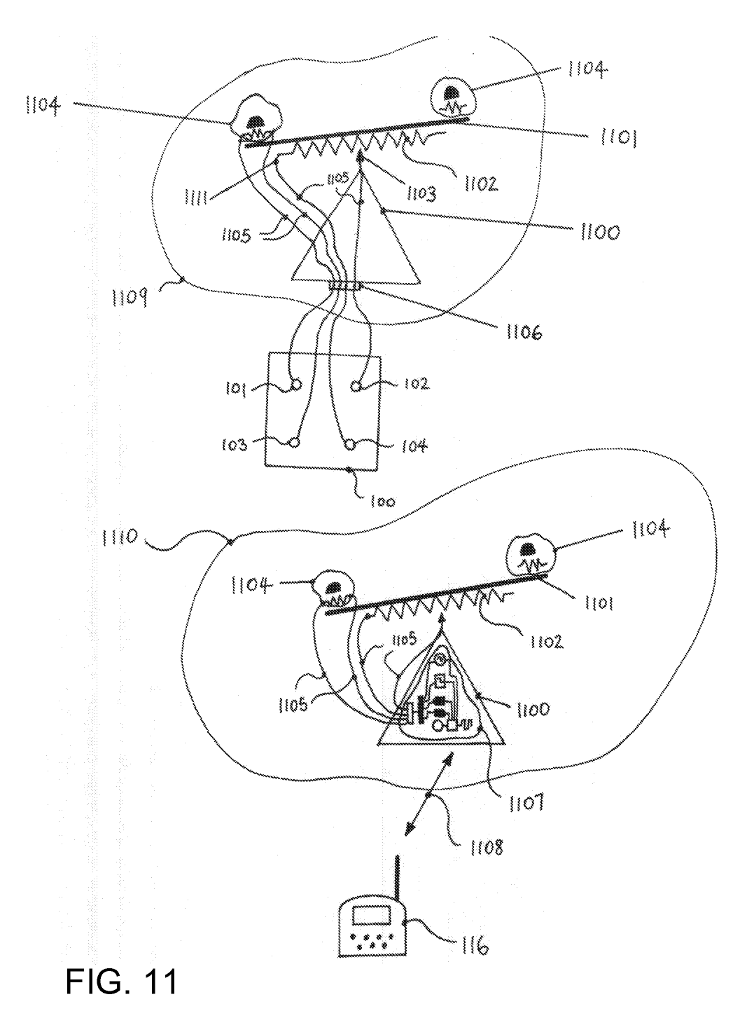

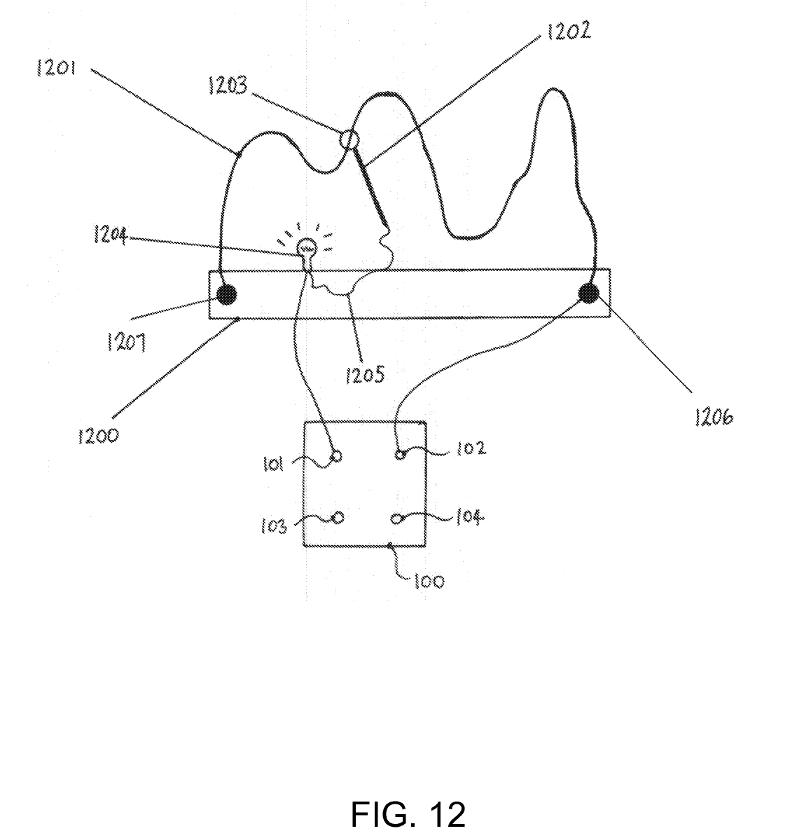

FIG. 1 depicts one embodiment of a system with grid 100 of a multiplicity of two or more connectors such as 101,102,103,104 which are connected by a group of one or more multiplexer switches 106 via the electrical wire 105 to a second group of one or more multiplexers 107 that in turn connect to either outputs or inputs that are applied to the connectors. The outputs include a variable power supply 108, Digital to Analogue Converter (DAC) 110 or digital outputs generated by the processor 112 or digital output via the GPIO 125 The inputs into the processor 112 include an Analogue to Digital Converter (ADC) 109 or digital inputs 125. Electrical control wires 120 from the processor 112 uses the multiplexer 106 to select the connector which is connected by to 107. Electrical control wires 121 from the processor 112 uses the multiplexer 107 to select the output 105 which is connected by to the processor.

To output different data to more than one node simultaneously or collect data from more than one node simultaneously, additional node multiplexers 106 and input/output multiplexers 107 are employed which connect to additional input and outputs to the processor. The system shall check all the nodes 101,102,103,104 by switching the multiplexers 106. 107 between each node and between the required measuring ADC 109, digital GPIO 125 or DAC 110 or power supply using control wiring 120,121.

Additionally, digital input/outputs connections 123 to the connectors 101, 102, 103, 104 can be made circuits such as 122 which have General Purpose Input Output (GPIO) inputs and outputs 123 that are can be programmed to output or receive input from the connection 123 via electrical bus connections 124 of various kinds include standards such as I2C© and 1-Wire© and similar which communicate with the processor 112.

Additionally, an input probe electrical connection 118 can be used to read via an Analogue to Digital Converter (ADC) electrical inputs by the processor 112. Additionally, an output probe electrical connection 119 can be used to output via an Digital to Analogue Converter (DAC) electrical inputs from the processor 112 to nodes selected by the used on the connector grid 100.

The grid may also have set connector/nodes set to a range of fixed supply voltages such as +5V 131, +3V 132, 0V 130 and −5V 133 as some non limiting examples.

The system is powered by a power supply or battery 111. The processor 112 is connected to an antenna 113 with which it communicates using low power RF 115 such as Bluetooth low energy with mobile computing device 116 which is executing software 129 that is running a sensor grid lesson 130 interacting with the user with a mixture of content, such as text, video and interactive questions as some examples as well as circuit verification profile 134 that is used to check circuits that the user may construct using electrical components between any number of two or more nodes, where FIG. 1 shows four nodes 101, 102, 103, 104.

For a given lesson, the sensor grid lesson 130 and the circuit verification profile 134 are stored together in the lesson/profile database 131. As the lesson is run the results of the user to completing the lesson including number of mistakes, attempts and if they completed or fixed the circuit as well as any scores are stored for review by other users or a teacher for example whom may have been also the original creator and uploading for of the lesson/profiles to the database 131.

When the sensor grid lesson 130 is downloaded to the mobile computing device and run, where there is code to execute on the mobile computing device or code to program into the processing unit 112, the action is seamless to the user being performed automatically. This is an advance over current electronics experimentation boards where the program must be uploaded to the board.

The system comprising of a sensor grid that receives inputs and produces outputs according to a lesson plan comprising of teaching content with integrated physical checking content which may be downloaded from other users or shared to other users. The system can check a node to see if the correct components are connected. To achieve this, some combination of ADC and DAC as well as digital Input Output and power supplies applied in order to test a component. In this way the user will be able to view the complete analysis and response of a component on the display of the mobile computing device and be able to interact with the variation of stimuli for measurement as well as view graphs.

The application of ADC and DAC as well as digital Input Output and power supplies is used to apply voltages and currents of varying magnitudes to the node connected to the component and measurement of the various voltage, current and time responses in order to measure resistance, capacitance, inductance and semi conductor properties as some non limiting character as well known to the field of in circuit testing of components and overall circuit measurement. One component can be measured in isolation if its other side is connected to ground.

Additionally another function of the system is to check the voltages and currents at nodes to see if they respond in a “static” state when no external stimulus is applied, but only the power to circuit, which may be useful to confirm that the circuit is wired correctly based on voltages and currents at set points. A check can also be done of the “dynamic” response of the system when additionally to power to the circuit, stimuli is applied or the system is otherwise allowed to function and generate responses. The circuit can be verified to be wired correctly based on voltages and currents at set points when stimuli are applied by the user or other external perhaps synchronized by the issuing of instructions to a user to create. Alternatively, the signals can be configured to be applied at nodes using the DAC to provide stimulus.

Video or audio recording of the operation of the circuits and or accompanying experiments measured by the circuit as instructed by the lesson content may also be uploaded and shared. When it is viewed it can be view with any accompanying telemetry and screen displays in sync with the video. For example an integrated lesson may show a graph of pressure over time. The video can be recorded at the same time by the system. On play back the video and graph will be in synchronization with the results.

All users of the same lesson, or of a define group such as a class may be able to view each other's results.

As an alternative to the use of multiplexers 106,107,200 or 208, or alternative wiring arrangements, the connectors may be directly joined to the processing unit, as well as optionally through a driver/buffer circuit.

The ADC and DAC as well as digital Input/Output may be inside the processor 112.

FIG. 1 shows four connectors for simplicity and clarity. A typical number of connectors may be nine or twelve connectors node from which many practical circuits can be constructed but an unlimited number could be supported.

Additional fixed power connectors may be added for commonly used power supply voltages such as 0V, 5V, −5V, 3V, −3V, 12V, −12V.

The software 126,129 on the mobile computing device 116 and the processing unit 112 allows the collection and display via the ADC of electrical waveforms such as displayed on a waveform.

In one embodiment, the processing unit 112 and software 126 shall be able to use the ADC 109 to sample and store electrical signals and waveforms and store in memory for later transfer and display on the mobile computing device 116 showing a display with functionality similar to an oscilloscope. The user may also select set waveform shapes and frequencies as well as define custom waveforms which are converted using a DAC into an analogue signal 110 which can be applied to grid connectors via the multiplexers.

In one embodiment, the grid sensor lesson may contain only program code, where the program code is downloaded as a lesson 130 from the database 131 by the mobile computing device 116 and then uploaded into the processor 112 to be interpreted or if the code was compiled, directly run by the software 126. The software 126, could run for extended periods of time autonomously where the data is periodically synchronized with the mobile computing device. In this manner it is possible for programs to be shared by users via the database 131 or also uploaded from another users mobile computing device 116 and then directly run as embedded code on the processor 112. The code running on the processor 112 can also store data from sensors which can be uploaded to the mobile computing device 116. Alternatively, a lesson may contain two types of code defined by the user. As described some of this code can be downloaded into the processor 112 driving outputs and reading sensors. A second type of code on the mobile computing device 116 can also run independently and simultaneously, communicating with the code on the processor 112. In one example, this may be used to facilitate some operations running in real-time at speed on the processor 112 that then reports back data to the user defined code on the mobile computing device 116 which may display the results on a display using text, images, audio, video or other content as well as communicate controls to a users. Additionally, a lesson may contain a third type of user defined code which has input/output communication with the code on the mobile computing device 116 and can send and receive data and control functions via a remote website or server. This may allow remote control of the sensor grid and aggregation of results and control from a remote server.

In another embodiment, one node may have one or more wires 105 connected to ADC, DAC, power supply and digital IO using additional multiplexers 106,107. This will allow for example, testing of node by simultaneously injecting a power or DAC signal and at the same reading the response of the a component to the power supply or DAC, or digital signal.

Referring to FIG. 1,

100—grid sensor board comprising of electrical contacts 101,102,103,104 wired through multiplexers 106 and 107, 200, 208 or directly to the processor or using other alternative multiplexing/demultiplexing wirings or arrangements. Four nodes are described for ease of description, but an unlimited number of nodes can be supported as well as addition unlimited multiplexing/demultiplexing and wiring.
101—node labelled “A”, an electrical connector which component's wire legs and connectors, and wires themselves can be temporarily or permanently joined to by means of insertion between a spring, through a loop, by a magnet to close the connection as well as other methods. This connector is joined by a wire 105 to a multiplexer 106, 200, 208 or directly to the processor 112. Or joined to the processor via a electrical driver and or isolation or protection circuitry. Protection circuitry can also be placed between the node and multiplexer.
102—node labelled “B”, an electrical connector which components wire legs, or connectors, and wire themselves can be temporarily or permanently joined to by means of insert between a spring, through a loop, by a magnet to close the connection as well as other methods. This connector is joined by a wire 105 to a multiplexer 106, 200, 208 or directly to the processor 112. Or joined to the processor via a driver and or isolation or protection circuitry. Protection circuitry can also be placed between the node and multiplexer.
103—node labelled “C”, an electrical connector which components wire legs or connectors, and wire themselves can be temporarily or permanently joined to by means of insert between a spring, through a loop, by a magnet to close the connection as well as other methods. This connector is joined by a wire 105 to a multiplexer 106, 200, 208 or directly to the processor 112. Or joined to the processor via a driver and or isolation or protection circuitry. Protection circuitry can also be placed between the node and multiplexer.
104—node labelled “D”, an electrical connector which components wire legs or connectors, and wire themselves can be temporarily or permanently joined to by means of insert between a spring, through a loop, by a magnet to close the connection as well as other methods. This connector is joined by a wire 105 to a multiplexer 106, 200, 208 or directly to the processor 112. Or joined to the processor via a driver and or isolation or protection circuitry. Protection circuitry can also be placed between the node and multiplexer.
105—a electrical wire connecting nodes to the multiplexers 106, 200, 208 or to the processor 113, as well as providing a connection between multiplexers 106,200,208 and multiplexers 107, 201.
106—multiplexer switch selecting one of the four nodes to be electrically connected to the multiplexer.
107—multiplexer switching the selected node via 106 to input/outputs 110,109,108 and 125 connected to the processor 112.
108—Power supply with programmable voltage and current levels driven controlled by the processor 112 and software 126. Current limiting can also be programmed by the processor. It may incorporate a PWM and or DAC.

### 109—Analogue to Digital Converter, ADC

110—Digital to Analogue Converter, DAC, This can be used to generate waveforms for output to nodes. Pulse Width Modulation (PWM) and filters may be used as part of this component.
111—Power Supply, from plug pack, battery, solar, capacitor
112—processing unit. It contains software instructions 126. It also generates the communications for transfer of sensor data using, but not limited to, low power RF conforming to standards such as Bluetooth 4, Bluetooth low energy and Bluetooth. The processing unit may also include an analogue to digital converter to convert sensor values.
113—antenna, supports but not limited to, low power RF conforming to standards such as Bluetooth 4, Bluetooth low energy and Bluetooth.
114—electrical or light communication connection to the mobile computing device 116.
115—communication using low power RF such as Bluetooth and Bluetooth 4 and Bluetooth low energy. Communication between the processor 112 and mobile computing device 116
116—mobile computing device, such as smart phones, mobile phones, cell phones, tablets, including iPhones© and Android© phones. Also laptop and fixed computers. Comprising of a hardware or software keyboard, display, processor, antenna, memory, applications and operating system. radio communication such as 3G, 4G, including internet on cellular networks. Iphone and Android are two typical non limiting examples.
117—laptop, fixed computer or mobile computing device with the same functionality as 116. It may be used to view the results of a lesson from the user of 116. A teacher may be on such example user
118—An Analogue to Digital ADC probe input processor 112 that the user can manipulate freely in the same way as an oscilloscope probe
119—A Digital to Analogue DAC output probe from processor 112 that the user can manipulate freely use to inject a signal into the circuit.
120—selection wires from the processor 112 to choose the node that is switched by multiplexer 106, 200, 208
121—selection wires from the processor 112 to choose the input ADC or Output Power Supply, DAC or Digital IO that is switched by multiplexer 107, 201.
122—Digital General Purpose Input Output (GPIO) integrated circuit that communicates with the processor 112, in one instance by I2C and connects via electrical wires 123 to nodes 101,102,103,104. The GPIO can send and or receive digital signals to and from the nodes. The nodes may be Simultaneously or multiplexed sensored.
123—electrical wires connecting digital inputs and outputs between the GPIO 122 and the nodes.
124—communicates with the processor 112, in one instance by I2C or other protocols to the GPIO
125—Connector for Sensors and other devices that can be added in addition to components on the sensor grid. The connector may support I2c, 1-wire, SPI and similar protocols.
126—software in the processor 112 to send sensor values, results and responses and receive commands on which sensors or outputs to apply to which nodes on the sensor grid 100. The software can also collect or drive outputs to devices and sensors and outputs connected to 125. The software communicates this information with the Mobile computing device 116. This software is capable to receive and execute a program from mobile computing device created by the user or compiled commands to execute. This program may have been created or configured in the grid sensor lesson for execution on the processor 112 and the program may be downloaded to the processor 112 as code that the this software interprets and runs, or as code that is compiled and runs as part of the native instructions on the processor or it may be downloaded an be the main program that executes on the processor.
127—Digital input/output port or input/driver
128—down loading of a sensor grid lesson 130 containing a circuit verification profile 134
129—software in the mobile computing device 116 which displays the lesson, and uses the circuit verification profile, as well allows the download or upload of lessons as well as results and raw sensor results. The software allows nodes to have a sensor type associated with it so that a standard display symbol with automatically defined levels, colors and Images for different values can be defined. Additionally the association of a sensor type allows a conversion between the raw value current or voltage and scaled value in the type of property being measured. To accomplish this scaling or mapping the conversion formulas or tables can be used. New sensors with these associated scaling and mapping characteristics can also be associate with a circuit verification profile. This software is capable to receive and execute a program from sensor grid lesson containing also a circuit verification profile created by the user or downloaded from the sensor grid lesson database. The software includes the API as well as a language interrupter used to support the creation of the content and logic that interacts with the grid sensor electronics including the grid sensor board 100, multiplexers 106,107,200,208 and processing unit 112 and all associated components can be JavaScript, python, basic, and all such similar languages or a combination as well as graphically orientated methods for defining graphical symbols and action associated with each sensor value to cause the display of different symbol states, images, coloring, filling levels as well as audio able outputs. The language or graphical symbol definition configuration methods used to support the creation of the content and logic should also provide the user with the ability to compute logic optionally using sensor inputs and or user interface selection to drive outputs supplied to components on the grid sensor. The software can also download code from the sensor grid lesson fro execution on the processor 112.
130—a sensor grid lesson interacting with the user with a mixture of content, such as text, video and interactive questions as some examples as well as comics and cartoons
131—database of elements of 130 and 134
132—mobile computing device of type 116, from where a user shares/uploads a sensor grid lesson 130 and circuit verification profile 134
133—uploading of a sensor grid lesson 130 containing a circuit verification profile 134
134—circuit verification profile as shown in FIG. 8 as one example
135—One or more 0V or negative supply pins
136—one or more +5V or other positive supply pins

FIG. 2 depicts one embodiment of a system with grid 100 of a multiplicity of two or more connectors such as 101,102,103,104 and multiplexers 200,208 and 201 connecting inputs and outputs to processor. In this circuit the use of two multiplexers 200 and a two pole multiplexer 201 version of 107, allows the measurement of a component by passing a current through the component. If other components are connected to the circuit depending on the arrangement they may also be incidentally measured complicating the measurement of the isolated component value of interest. This isolation can also be improved by using of the arrangement of FIG. 10 in conjunction with the isolation of “pre-node” from the node or any other technique that isolates nodes to allow more targeted measurement of one or a group of specific components.

The multiplexer 201 switches two wires so that for example a Power Supply output may be selected where the power supply positive is 206, the current flows through the 206 and 208 to one node 102, then through a resistor component 209 being tested and then from node 101, and back out via 200 and the negative wire 207 of the power supply. In the case of a resistor the application of a known power supply voltage and the measurement current flowing through this loop will allow the calculation of the resistance.

If instead of the power supply, the DAC is used then time, frequency variation of DAC would allow frequency response/time constants of components such as capacitor or other components including semi conductors to be determined.

Multiplexer 201 can be used to determine the whether DAC, ADC, power supply or digital is applied and multiplexers 208 and 200 through which two nodes the test is applied. The additionally wires to allow the circuit to complete for the nodes are labeled 202, 203, 204, 205.

In the case of ADC measurement if the circuit has power supplied then the voltage and frequency time variation of the voltage can be measured between the two points and the component characteristic between the two nodes selected by the multiplexers 200, 208 can be measured.

When the mobile computing device 116 which is executing software 129 that is running a sensor grid lesson interacting with the user asks the user to place a resistor in the position 209 of a certain value then the circuit verification profile 134 or code in the lesson is used to check if the resistor value is correct by passing a current through as described above. If the resistor is not placed or with an incorrect value the user is informed that the step has not be completed correctly. Similar variations can be applied to other types of components. In the manners described above, there are at least four ways that the circuit verification profiles such as shown in FIG. 8 or FIG. 9 can be applied to check a circuit. Firstly, by having no external voltages applied to the circuit and measuring by use of the power supply or DAC via 107 the response of one node and ground (or other power rail) to the applied power supply or DAC. Alternatively, by having no external voltages applied to the circuit and measuring by use of the power supply or DAC via 201 the response between one node and a second node to the applied power supply or DAC. In FIG. 7 where entries in the mode column label “component” are values checked in this way. Secondly, by having an external voltage applied but without variation of stimuli to the circuit the steady state voltages of nodes can be check against entries in the mode column labeled “static”. In the case of FIG. 1, the voltages are checked between the node and 0 v. In the case of FIG. 2 the voltages are checked between the two selected nodes. Thirdly, by having an external voltage applied and also the variation of stimuli to the circuit the dynamic voltages ranges of nodes can be check against entries in the mode column labeled “dynamic” to check with the upper and lower range. In the case of FIG. 1, the voltages are checked between the node and 0 v. In the case of FIG. 2 the voltages are checked between the two selected nodes. Fourthly, digital levels at all or some nodes can be checked by using for example a GPIO 122 set to output all combinations of, in this case “A” and “B” and “C” in FIG. 8 which have been specified as inputs to test digital circuits statically to see that the verified output “D” meets the condition of the truth table.

In another embodiment, the system monitors the operation of the circuit and checks dynamically as the circuit is used that it never violates the values in the table as the circuit is used and warns when a volition to the test is found, if at all.

In FIG. 2, the ADC 109 is connected across the resistor component 209 by the wire 205 starting from the ADC connecting via 201,208 to Node “B”, then through the resistor 209 and from Node “A” via 200,201 via a wire 206 to the other side of ADC 109.

In FIG. 1 and FIG. 2, if desired, more than one Digital to Analogue Converter (DAC) 110 or power supply 108 and one or more Analogue to Digital Converter (ADC) 109 may be used simultaneously to determine the characteristics of a component such as a transistor where the base emitter must be excited and then the collector base current measured. In this circuit the use of two multiplexers 200,208 and a two pole multiplexer 201 version of 107, allows the measurement of a component by passing a current through the component. If other components are connected to the circuit depending on the arrangement they may also be measured complicating the measurement of the isolated component value of interest. This may be further over come by introducing additional isolation citrusy so that each node can be isolated to over come this problem which referring to FIG. 10, is provided by An additional switch 1005 can be opened to isolate the “pre node” from the node to assist in circuit testing where the all or some other components can be isolated so that each component can be tested in isolation. Additionally if required for testing, a switch 1006 to ground 0V which is normally open can be closed. If switch 1005 is open then only the selected “pre-node” will be switched to ground otherwise if the switch 1005 is closed both the node and “pre-node” will go be grounded 0V. This logic and similar variations can be applied to all pre-nodes and will help provide more possibilities to isolate the components in the circuit.

The software allows nodes to have a sensor type associated with it so that a standard display symbol with automatically defined levels, colors and Images for different values can be defined. Additionally the association of a sensor type allows a conversion between the raw setting in terms of current or voltage and scaled value in the type of property being measured.

Where more than one component is connected in parallel between two or more nodes being measured, the circuit can be verified to be correct for the response to measurement at those nodes that is the sum of the overall effect of the connected components as in some circumstances if this sum or overall value is correct then the circuit has been wired correctly.

For reference with FIG. 2,

200—multiplexer switching the selected node via 106 to input/outputs (10) 110,109,108 and 125 connected to the processor 112. In this case the selected node is “A” 101 which is the first side of the resistor 209 and the Input/output type is Power supply 125 which has a current sensor so that using V=IR where V and I is known the resistance of 209 can be determined. In FIG. 2 the circuit for testing of the resistor 209 by application of Voltage and current from 125 involves a circuit loop using wires 206, 202, 209, 203 and 207.
201—multiplexer switching the two wires 206 and 207 closing the circuit so that current from the power supply can flow through 209 for sensing.
202—Wire connection from Node “A” to multiplexer 200 which can be used to connect a node to the other side of an ADC, DAC, digital IO or power supply to allow isolated measurement or application of a signal to a component. The two nodes selected for the completion of the circuit are determined by the multiplexers 201,200,208. In FIG. 2, the ADC 109 is connected across the resistor component 209 by the wire 205 starting from the ADC connecting via 201,208 to Node “B”, then through the resistor 209 and from Node “A” via 200,201 via a wire 206 to the other side of ADC 109.
203—Wire connection from Node “B” to multiplexer 200 which can be used to connect a node to the other side of an ADC, DAC, digital IO or power supply to allow isolated measurement or application of a signal to a component. The two nodes selected for the completion of the circuit are determined by the multiplexers 201,200,208.
204—Wire connection from Node “C” to multiplexer 200 which can be used to connect a node to the other side of an ADC, DAC, digital IO or power supply to allow isolated measurement or application of a signal to a component. The two nodes selected for the completion of the circuit are determined by the multiplexers 201,200,208.
205—Wire connection from Node “D” to multiplexer 200 which can be used to connect a node to the other side of an ADC, DAC, digital IO or power supply to allow isolated measurement or application of a signal to a component. The two nodes selected for the completion of the circuit are determined by the multiplexers 201,200,208.
206—multi coloured led used to indicate if node value is correct green or incorrect, red. Led could exist next to all nodes
207—multi coloured led used to indicate if component is correct green or incorrect, red. Led could exist between all nodes
208—multiplexer switching the selected node via 106 to input/outputs 110,109,108 and 125 connected to the processor 112. In this case the selected node is “B” 102 which is the second side of the resistor 209 and the 10 type is Power supply 125 which has a current sensor.

FIG. 3 depicts one embodiment of a balloon internal pressure graph 399 showing the continual increase in pressure 306 inside a balloon as a person blows 305 up a balloon until it pops 307. The y-axis shows pressure 300 as measured from a voltage involving the pressure sensors resistance in series with a second resistor. The x-axis shows time 301 over which the balloon is blown up. Note the spike in pressure 305 each time air is blown in. Initially the pressure is low before air is blown in but as air is blown in initially the pressure rises 303 and then reduces as the 304 as the rubber expands.

For reference with FIG. 3,

300—Graph y-axis representing the pressure, displayed as a voltage at node “C” 103 and pressure.
301—Graph x-axis representing time, in this case in seconds
302—The pressure/voltage inside the balloon at ground atmospheric temperature before the balloon is beginning to be blown up by a person with their breadth
303—The pressure/voltage inside the balloon after a large initial breath of air is pushed in causing a big spike in pressure
304—The pressure/voltage inside the balloon reduces following the large initial breath of air is pushed in as the rubber of the balloon expands increasing the volume of room in the balloon and hence pressure.
305—subsequent spikes in pressure/voltage spikes and overall increases as the user blows more air into the balloon.
306—subsequent reduction in pressure/voltage following the spikes 306.
307—The pressure/voltage returns to ground atmospheric temperature before the balloon was begun to be blown up after it has popped.

FIG. 4 depicts one embodiment of a circuit mounted on the grid 100 with a pressure sensor 401 inside a balloon 400 where the pressure sensor output is connected by wire 403 to a resistor 404 at node “C” which is in turn connected to 0V. The pressure sensor 401 has its +5 V power supply connected to the +5V battery power supply 402 and its 0 v connected to the negative terminal of the battery 406 via node “D” 104.

The graph in FIG. 3 shows the voltage from the pressure sensor output, and hence pressure at node C 103. The voltage will range from 0.2 v from to 4.2V as the pressure in the balloon increases towards finally popping.

For reference with FIG. 4,

400—Party balloon made of rubber or similar material that can be blown up by a person
401—pressure sensor placed inside the balloon to measure the pressure as the balloon increases which is joined by two wires 403 to nodes on the grid sensor 100. In this case 2 k Ohm.
402—positive voltages such as +5 v applied through this wire to 101
403—wires joining pressure sensor 401 to nodes on the grid.
404—A 2 k Ohm resistor in series with the 401
405—battery

FIG. 5 depicts one embodiment of a grid sensor lesson comprising of a series of steps 500, 501, 502, 503, 504, 505,515 and content to display to, and interact with the user for each step. During the lesson the circuit verification profile 899 is used to check that the circuit has been wired correctly at step 502. The lesson subject and content as well as number of steps and interaction with the grid sensor is fully variable and dependent on the user. While the term lesson has been used to describe the content, a user could define content that has no educational value but is simply a game with content and grid sensor working together to create the game.

Lessons can be created and uploaded for sharing by one user from another mobile computing device 132 for download and use by other users 116. The Lessons can be created on the mobile computing device 116, or another device b or from configuration software hosted on a website or from configuration software installed on a personal computer such as a laptop or fixed desktop.

During the creation of the lesson, any number of pages corresponding to the steps shown in FIG. 5 can be created. Content can be defined on pages by methods such as drag and dropping text boxes, buttons, images, video, audio, titles and all such similar content. In the case of elements such as buttons, the pressing of the button can be linked to the call of code such as but not limited to simplified JavaScript which can access API including exposing variable corresponding to node sensors and outputs, that send and receive data to and from the sensor grid or control the multiplexers. The code can be compiled when the lesson is created or interpreted by software on the mobile computing device 116 or lesson grid processor 112.

API calls can also be defined to check all, or sections of a circuit verification profile 899 for wiring or other connection mistakes, “component mode” as well as problems with the circuit when power is applied “static mode” or when the circuit is running “dynamic mode”. Typically the lesson would be configured so that the user is given an instruction to connect components or input signals to a circuit then the appropriate component, static, or dynamic mode step(s) would be applied to check that the conditions have been satisfied and the circuit is wired correctly and or the user applied or sensed properties are correct.

API calls can be called from the user defined javascript to read connector mode voltage values using the ADC 207 and multiplexers which can be configured by the javascript language to display a value in a text box on the screen, and or check the value against a reqired value and or display a corresponding graphic depending on the value and or display the output in graphical format.

API called that take values input on the display in one of the steps and output them via the DAC and multiplexers. API calls can also be defined to read and write digital values via the GPIO or digital I/O 125. API calls can also be defined to set power supply values that can be applied to connector nodes.

For the purposes of this description, the pressure sensor 401 voltage increases with and increase in pressure. At normal atmospheric level the voltage is 0.5 v and increases up to the balloon popping around 4.2 V at which point the pressure is the highest.

At step 500, the user is introduced to the concept or pressure and balloons rubber material and elasticity and the question posed what will happen when the balloon is blown up. At step 501, the user is shown a circuit diagram 507 which they are asked to wire up. At step 502, the user is shown the same circuit diagram 507 with the components shown as the components are wired up then a message confirms correct placement for the pressure sensor 516, resistor 517, when the user has placed them in the correct place. The battery is not requested to be placed at this stage to allow the component test. Placing the battery in parallel with the sensor and resistor would affect the reading of the resistance values. To determine if the component in place is correct value and orientation the CheckComponentProfile is called with the step 801 number passed in as an input parameter.

The CheckComponentProfile uses the step number that you input as an argument to access the row in the table for “component” mode and uses the DAC or power supply via the multiplexers to apply a voltage to the appropriate node(s) and measure the voltage and current response from which the components correct orientation and value can be verified.

Resistance, capacitance, inductance and semi conductors such as diodes, transistors as some non limiting examples can be tested using techniques well known to in circuit testing.

Logic gates with multiple combinations and states need to be checked against a defined truth table FIG. 9 by calling a function CheckDigitalTruthTable

The code demonstrates also the display of images that can be configured be drawn to make the display more engaging for the user using the a command such as Drawlmage were co ordinates for display as well as the image, in this case “GreenTick.jpg” to show can be defined. The image can be uploaded for inclusion along with other content as part of the lesson.

For example,

```
// one example circuit where the lesson has integrated / interactive
// checking built into the lesson .
while(true)
{
      // check the pressure sensor typically 100k ohm
      if( !CheckComponentProfile(1))
      {
            DrawText(10,50,”Pressure sensor in place”);
      }
      //check the resistor is about 2k ohm
      if( !CheckComponentProfile(2))
      {
            DrawText(10,50,”Resistor in place”);
      }
      if( !CheckComponentProfile(3))
      {
            DrawText(10,50,”The two resistor series resistance
            is correct”);
            // Draw an Image that shows graphics with a green tick.
            DrawImage(50,100,”GreenTick.jpg”);
      }
      if(CheckComponentProfile(1) && CheckComponentProfile(2))
      {
            DrawText(10,50,”Everything is ready”);
            Sleep(10);
            NextStep( );
      }
      Sleep(5);  // wait for 5 second.
}
```

The value for the nodes 101,102,103,104 being respectively “A”, “B”, “C”, “D” can be read in the program and assigned to other variables. The reference in the program to the letter C allows access to the value. Values are by default inputs but for example D can be set to an output by calling a “set” function with the value “set(D,200);” as one example or by simply specifying “D=200”. If the node is to be consider as a digital Input or Output (10) then a function “MakeDigitalInput(D);” and “MakeDigitalOutput(D);” must be called to set system to use the appropriate multiplexer options. Alternatively, a datatype “integer” and “unsigned integer” can be used to specify integer variables so that when they are assigned to a pin, the system will know that they are a variable integer non digital type. The datatype “binary” can be used to specifiy binary variables where again the system will known when reading or writing to the node that it is digital. The multiplexer options 120,121 will be chosen automatically by the system to set to which node and which type of ADC, DAC, power supply or digital IO to apply according to the data types being set and or read as requested by the lesson code as it either reads or writes to variables as well as reading sensor values to directly draws graphs and take user input to output using the power supply, DAC and digital outputs and GPIO.

In another embodiment, At 502, a variable could be created to count when the loop has been made for 2 minutes and then a hint displayed using DrawText for the resistor or pressure sensor according to which one is not in place.

In some embodiments, a circuit schematic program can be used to generate definition file from which not only can a display to the user be create but also a configuration of values to check as shown in FIG. 8 and FIG. 9.

At step 503, the user is asked to add the battery 407 and press a check button 508 on the display of the mobile computing device 116 or a physical button on the sensor grid, the pressing of the button has been configured by the creator of this lesson to call the CheckStaticProfile function which looks up with the step number entered the value the correct value that should be found if the circuit has been correctly wired. Alternatively, to the check button, the circuit automatically checks till everything is correct in a loop. In the case of verifying the circuit after the battery has be applied but no external stimulus, termed the “static” mode, the ADC 109 and multiplexers are used to measure voltage across the node(s) to be measured and these checked again the circuit verification profile 899. A cross out section 509 on the circuit or component as one example is shown to indicate the placement of one component is incorrect when the checking has been done.

For example,

```
while(true)
{
    if(CheckStaticProfile(1) && CheckStaticProfile(2))
    {
            DrawText(10,50,”Battery ready well done”);
            Sleep(10);
            NextStep( );
    }
    Sleep(1);  // wait for 1 second.
}
```

A call can also be made to a function that does all of the checking for each type for example, CheckAllComponentProfile( ) CheckAllStaticProfile( ) CheckAllDynamicProfile( ) or CheckAllProfile( ). In the case of CheckAllProfile( ) the user is prompted to apply the power supply and stimuli during the testing.

At step 504, the user is shown the pressure changing with time. When the pressure reaches a value corresponding to 4V then we would like to make the lesson fun and interactive by asking them to enter the pressure in kPA or V at which will pop.

To display the graph, the following code is configured to draw the graph and read the voltage value from connector node “C” and display on the screen as well as move to the next screen when the pressure expressed as voltage gets close to popping 4V. A check against the profile, FIG. 7, is done by calling the “CheckDynamicProfile” function with the step number set in this case to 1 to check the step 1 rule for the dynamic mode 714. The “CheckDynamicProfile” function will check that node C voltage value lies in the range of greater than 0.5V and less than 4.2V where 0.5V is the value when there is almost no air in the balloon. The value should be higher that 0.5V as the balloon inflates with the overall voltage at C increasing with pressure as the balloon expands.

For example,

```
// Draw a graph with origin at X,Y = 100,400 which is 200x200
// The graph is displaying the value C
// Where when a node is to be used in with a function for
// example in this case setGraph to plot the value of
// node C which is element 103 in Fig 1, then
// the node letter is passed in as the first argument
setGraph(C,100,400, 200,200);
// the range for the Y axis for graph for C is 0.5 to 4.5 V
setGraphRange(C,Y,0.5,4.5);
setGraphXLabel(C,”Time”);
setGraphYLabel(C,”Pressure (V)”);
//loop sampling C every second till reaches 4V then next step
while(true)
{
    if(C>4) NextStep( ); // getting close to poping at 4.2
    ask question
    // check and warn the user if pressure goes out of range
    // this may happen if balloon deflates too much
    //
    if( !CheckDynamicProfile(1))
    {
        DrawText(10,50,”Please check the balloon it has delfated”);
    }
Sleep(1);  // wait for 1 second.
}
```

Where a node is to be used in with a function for example in this case setGraph to plot the value of node C which is element 103 in FIG. 1, then the node letter is passed in as the first argument.

At step 505, the user is shown an user entry text box 512 and text 513 asking them to enter the values for the pressure in V at which the balloon will pop. The screen then displays the value 513 until the balloon is sensed to have popped by the voltage returning to 0.5V, which was the value before it the balloon was started to be blown up. And the user is told congratulated if they guessed the correct value 514.

For example,

```
// Define a global variable to display to pass message to next // step screen
Global string GuessMessage = “Sorry you guessed wrong”;
// Draw a graph with origin at X,Y = 100,400 which is 200x200
DrawText(10,50,”Please enter guess for V at balloon pop”);
int popVal = GetValue(10,70);
// loop until the pressure falls back to the popped pressure of 0.5V or less.
int lastValue = 0;
while(true)
{
    if(C<=0.5)
    {
            // see if they guessed the correct value.
            if(lastValue == popVal)
            {
                GuessMessage = “You Guessed Correctly !!”;
                DrawText(10,50,GuessMessage);
                Sleep (5);
            }
            NextStep( ); // getting close to poping ask quest.
    }
    //remember the last value before it popped which was the peek value
    lastValue = C;
    Sleep(1);  // wait for 1 second.
}
```

At step 515, the user is told by text 514 if they guessed correctly and theory is presented that describes why the pressure increases with the balloon blowing up, why the variations 305 occurs and why the pressure initially rises 303 and then drops 304. FIG. 3 may also be shown along with explanation text. The code style could be done in a variety of ways including an object orientated form or other styles. The code show here is representative of just one of any syntaxes possible. In addition to javascript, python, basic and other languages can be used.

In one embodiment, various forms of defining graphical animations including symbols showing different states according to sensor values from nodes, Graphs plotting the sensor values from nodes, numerical output of sensor values can be defined by use drag and drop to place the symbols, graphics, graph location and size and then associating the node(s) which they represent or symbolize. This input can be used to generate code or other methods for this configuration information to be executed. Various techniques such as this are well known for example in the SCADA industry to create representations of sensor values and their relationship to processes through graphical symbols, animations and numerical outputs. The sensor values taken and display on the mobile computing device's 116 display can be termed “telemetry”. Additionally camera and video can be configured on the same display and the video and photos can be recorded in synchronization with the measured sensor and applied outputs telemetry and also replayed in synchronization as well as shared so that other people can like wise view the video and photos in time synchronization.

In one embodiment, the lesson can be displayed and the user interacts with the lesson on the mobile computing device 116 while in another embodiment the user interacts with the lesson on a second computer or mobile computing device which communicated with 116 where 116 sends and receives the sensor and other signals to the second computer or mobile computing device. Multiple users using mobile computing devices 116 can access a single processor 112 and sensors grid either communicating with the processor 112 directly or via a mobile computing device 116 connected to it that then allows connection to the other mobile computing devices 116. A teacher may also access multiple student's mobile computing devices 116 to monitor the whole classes progress on multiple mobile computing devices 116.

In another embodiment, instead of circuit verification profiles holding the values to check such as upper range value 804, typical value 805 and lower value 806, the entire circuit can be simulated by circuit simulation software and the values stored at the beginning when the lesson is first created, or calculated as needed for “component”, “static” and “dynamic” modes. Alternatively, the creator of the circuit can wire up the circuit and then have the values recorded by reading from all or some of the nodes and storing these value for use when testing. In the “component” mode the components are determined by applying the DAC 110 or GPIO 122 or Power Supply 108 to the circuit and measuring the current or voltage response. In the case of the “static” and or “dynamic” modes when power and or stimuli is supplied the ADC 109 is used to measure the node values. In this way values do not need to be entered in a table manually by the lesson creator. If the component has three or more wires connecting it then if all must be measure simultaneously then they may all be given the same step number 801. In a similar way in the case of the digital circuit profile the values can be entered in manually or the circuits responses to different states can be recorded or the inputs and outputs nodes can be defined and then the system will automatically apply digital signals to the inputs via the multiplexers and digital I/O 125 or GPIO 122 and measure the outputs.

In one embodiment instead of making calls in the programming language to the check the profile tables using the functions, CheckStaticProfile, CheckComponentProfile, CheckDynamicProfile the checking functionality can be done by the user defining checks using custom defined code which is stored also in the circuit verification profile with the lesson that reads Node Voltages using the ADC and outputs voltages and currents to node using the DAC or power supply or also writes and reads digital IO.

At each step a user defined program can be created to combined the User Interface Elements and read and write operations to the sensor and outputs to and from the grid and display on the mobile computing device display and accept input from the mobile computing device display.

For reference with FIG. 5,

500—User Interface elements including Text, Images, Videos, Buttons, Graphs, Symbols, Animations, Input Boxes, introduced the user to the concept or pressure and balloons rubber material and elasticity and the question posed what will happen when the balloon is blown up.
501—User Interface elements including Text, Images, Videos, Buttons, Graphs, Symbols, Animations, Input Boxes show the user a circuit diagram 507 which they are asked to wire up.
502—User Interface elements including Text, Images, Videos, Buttons, Graphs, Symbols, Animations, Input Boxes show the user the same circuit diagram 507 with the components shown as the components are wired up then a message confirms correct placement for the pressure sensor 516, resistor 517, when the user has placed them in the correct place. The battery is not requested to be placed at this stage to allow the component test. The CheckComponentProfile uses the step number that you input as an argument to access the row in the table for “component” mode and the step number and uses the DAC or power supply via the multiplexers to apply a voltage to the appropriate node(s) and measure the voltage and current response from which the components correct orientation and value can be verified. The circuit verification profile 899 is used to check that the circuit has been wired correctly at this step. A user defined program can be also included to combined the User Interface Elements and read and write operations to the sensor and outputs to and from the grid to perform this functionality.
503—User Interface elements including Text, Images, Videos, Buttons, Graphs, Symbols, Animations, Input Boxes ask the user to add the battery 518 press a check button, the pressing of the button has been configured by the creator of this lesson to call the CheckStaticProfile function which looks up with the step number entered the value the correct value that should be found if the circuit has been correctly wired. A user defined program can also be included to combined the User Interface Elements and read and write operations to the sensor and outputs to and from the grid to achieve this functionality.
504—User Interface elements including Text, Images, Videos, Buttons, Graphs, Symbols, Animations, Input Boxes show the user the pressure changing with time similar to FIG. 3. When the pressure reaches a value corresponding to 4V then we would like to make the lesson fun and interactive by asking them to enter the pressure in V at which will pop. A user defined program can also be included to combined the User Interface Elements and read and write operations to the sensor and outputs to and from the grid to achieve this functionaility
505—User Interface elements including Text, Images, Videos, Buttons, Graphs, Symbols, Animations, Input Boxes show the user a text box and text asking them to enter the values for the pressure in V or kPA at which the ballon will pop. The screen then displays the value until the balloon is sensed to have poped by the voltage returning to 0.5V, which was the value before it the balloon was started to be blown up. And the user is told congratulated if they guessed the correct value. A user defined program can also be included to combined the User Interface Elements and read and write operations to the sensor and outputs to and from the grid and perform this functionality
506—User Interface elements including Text, Images, Videos, Buttons, Graphs, Symbols, Animations explaining about air pressure, elasticity and balloons
507—Shematic or mode child friendlt circuit diagram representation of the circuit with a balloon, pressure sensor wired inside the balloon with accompanying resistor and battery.
508—A button on the mobile computing device interface which has been configure to call a check to see if the static state of the ciruit is correct after the battery has been applied and output information in the form of an image showing the fault. Code is configured by the user to call the checking function when the button is pressed and display the information 509
509—information in the form of an image showing the fault.
510—Graph showing the pressure in voltage or pressure (kpa) as the balloon inflates as measure from node C. The display of which is defined by code configured by the user. user a text box and text asking them to enter the values for the pressure in V or kPA at which the ballon
511—text asking the user to enter guess of the pressure in V or kPa at which the balloon will pop
512—text box where the user enter guess
513—pressure value is displayed in this position.
514—Message congratulating the user if they guessed correctly is output if the user enter the correct value at which pressure the balloon would pop in 512.
515—User Interface elements including Text, Images, Videos, Buttons, Graphs, Symbols, Animations, Input Boxes firstly shows present the theory that describes why the pressure increases with the balloon blowing up, why the variations 305 occurs and why the pressure initially rises 303 and then drops 304. A user defined program can also be included to combined the User Interface Elements and read and write operations to the sensor and outputs to and from the grid
516—pressure sensor
517—resistor
518—battery
599—grid sensor lesson comprising of a series of steps 500, 501, 502, 503, 504, 505, 515

FIG. 6 depicts one embodiment of a puzzle in the form of flashing graphics on a display 600 of a mobile computing device. In different random or predetermined order or otherwise, the graphics labeled “A” for node “A” 601, the graphics labeled “B” for node “B” 602, the graphics labeled “C” for node “C” 603, the graphics labeled “D” for node “D” 604 flash. It happens that whenever node “B” 102 and node “C” 103 flash then the graphics labeled “D” for node “D” 604 flashes. The user solves the puzzle by noticing this and uses this as a clue to construct a logic circuit on the sensor grid that will simulate the pattern that causes the light 604 to flash when the same combination of nodes as shown in the flashing graphics occurs. The grid sensor lesson comprises of the display in FIG. 6 as well as circuit verification profile 899.

For reference with FIG. 6,

600—puzzle in the form of flashing graphics on a display
601—different random or predetermined order or otherwise, the graphics labeled “A” for node “A” flashes
602—different random or predetermined order or otherwise, the graphics labeled “B” for node “B” flashes
603—different random or predetermined order or otherwise, the graphics labeled “C” for node “C” flashes
604—different random or predetermined order or otherwise, the graphics labeled “D” for node “D” flashes

FIG. 7 depicts one embodiment for the user solving the problem by placing an AND gate 700 with the two inputs on 102 and 103 and the output on 104. The circuit verification profile 899 is used by the function “CheckDigitalTruthTable” to verify when the circuit is correctly wired as well as displaying hints if correction is needed.

For example,

```
// Checks the truth table Fig 9
If(CheckDigitalTruthTable( ))
{
    DrawText(10,50,”Correct”);
    Sleep (5);
    NextStep( );
}
else
{
    //returns some hints to solve the
    string hints= GetHintCheckDigitalTruthTable( );
    DrawText(10,50,hints);
}
```

For reference with FIG. 7,

700—a digital Integrated Circuit (IC) AND gate with two inputs connect to 102, 103 and one output connected to 104.
701—positive power supply +5V or +3V applied to power 700 and connected to a battery or other power source 405 or onto a +5V supply on the board.
702—0V power supply connected to the negative terminal of the battery or other power source 405 or into a 0V supply on the board.

FIG. 8 depicts one embodiment of a circuit verification profile for the example circuit shown in FIG. 4 which allows the monitoring of node “C” 103 voltage to display the change in pressure as a balloon is expanded. Referring to the type 807, all component values and techniques to measure can be employed as determined by the type in addition to resistance and voltage mentioned.

For reference with FIG. 8,

800—“mode” can be either firstly, “component mode” which checks the components by apply in ciruit testing techniques such as passing voltages and currents through components and checking responses over time to measure components and see if they have been correctly configured. Secondly, “static mode” checks voltages and currents at nodes when the power has been applied but not stimuli such as inputs or programs running Thirdly, “dynamic mode” checks the voltages and currents when the circuit and system is functioning
801—“step” each mode can have one or more steps with one step for component, or node to check
802—first node for one side of check of component or the node being check
803—second node for the second side of component to check
804—acceptable upper value of component or voltage or current
805—acceptable typical value of component or voltage or current
806—acceptable owner value of component or voltage or current
807—type of the value in 804,805,806 for example ohms, V, mF, etc. . . .
808—the component measurement details to measure. In this case the input resistance of the pressure sensor connected between node “A” and node “C” by passing a current or voltage using the power supply and measuring the current or voltage in response. In one mode, the power supply may have a constant voltage and measure the current from which using ohms law by the equation V=IR, the resistance deduced. The resistance should be in the range 80 k to 120 k ohms. In the component mode no external voltage is connected to power the circuit. All other component values and techniques to measure can be employed in addition to resistance mentioned here as just one example.
809—the component measurement details to measure. In this case the input resistance of the resistor connected between node “C” and node “D” by passing a current or voltage using the power supply and measuring the current or voltage in response. In one mode, the power supply may have a constant voltage ad measure the current from which using ohms law by the equation V=IR, the resistance deduced. The resistance should be in the range 1.8 k to 2.2 k ohms. In the component mode no external voltage is connected to power the circuit.
810—the static measurement details to measure the voltage at node “A”. The ADC is used to measure the voltage if the type is V as is the case here, it is defined as D then instead of the ADC digital IO or GPIO sampling is used to check if logic “0” or “1”. In this case the node “A” voltage is the power supply voltage between 4.8 and 5.2 V. In the static mode external voltage is connected to power the circuit but no stimuli the circuit is designed to react to are applied.
811—the static measurement details to measure the voltage at node “C”. The ADC is used to measure the voltage if the type is V as is the case here, if it is defined as D then instead of the ADC, digital IO or GPIO sampling is used to check if logic “0” or “1”. In this case the node “C” voltage is the voltage output corresponding to pressure which varies from 0.1V to 0.5V at atmospheric room pressure. In the static mode external voltage is connected to power the circuit but no stimuli the ciruit is designed to react to are applied.
812—the dynamic measurement details to measure the voltage at node “C”. The ADC is used to measure the voltage if the type is V as is the case here, if it is defined as D then instead of the ADC digital IO or GPIO sampling is used to check if logic “0” or “1”. In this case the node “C” voltage is the voltage output corresponding to pressure which varies from 0.1V at atmospheric room pressure to approximately 4.2V at the point that the balloon pops. In the dynamic mode external voltage is connected to power the circuit and stimuli is applied the ciruit to check the correct reaction to the stimuli are produced. Dynamic mode can also be run to monitor the circuit not just at a testing phase to verify circuit setup but at any time while the circuit is working to check that the circuit is always performing correctly. Circuits may stop working if for example a wire falls out
899—circuit verification profile

FIG. 9 depicts one embodiment of a circuit verification profile for the example digital AND gate circuit shown in FIG. 7. If all rows in this truth table are correct when the lesson grid sensor checks using the multiplexer applied to digital input/output of the GPIO then the circuit is correct and the puzzle is verified to have been solved.

For reference with FIG. 9,

900—node “A” input
901—node “B” input
902—node “C” input
903—node “D” output
904—when “B” and “C” are one “D” turns on regardless of “A” (which in this case is “0”)
905—when “B” and “C” are one “D” turns on regardless of “A” (which in this case is “1”)
999—when node “B” and node “C” are both 1 then the puzzle shows node “D” should be 1. If all rows in this truth table are correct when the lesson grid sensor checks using the multiplexer applied to digital input/output of the GPIO then the circuit is correct and the puzzle is verified to have been solved.

FIG. 10 depicts one embodiment of an alternative wiring method for node 101,102,103,104 to allow current measurement where up to typically four wires can be joined to a node but instead of joining directly to the node each wire joins to a “pre-node” 1000 connection. The “pre-node” is joined to the node via a switch 1003 that can be opened and closed. In parallel with the switch is a current measurement device that can be connected to an ADC which is connected through multiplexers to the processing unit. Normally the switch is closed and the component 1001 is joined to the node. However in order to measure the current the switch can be opened to allow the current to flow through the current measurement device 1004 so that current information can be displayed to the user and used to verify the circuit. An additional switch 1005 can be opened to isolate the “pre node” from the node to assist in circuit testing where the all or some other components can be isolated so that each component can be tested in isolation. Another switch 1006 can also ground to 0V the wire 1002 when switch 1003 is closed as well as the node 103 if the switch 1005 is closed.

For reference with FIG. 10,

1000—“pre node” connector which can be spring, magnetic, loop, solderable or connectable to a wire or wire from a component.
1001—example component for example a resistor.
1002—electrical connection wire
1003—switch
1004—current sensor as one example convert current to voltage to be read by ADC connected by multiplexers to a processing unit.
1005—An additional switch 1005 can be opened to isolate the “pre node” from the node to assist in circuit testing where the all or some other components can be isolated so that each component can be tested in isolation.
1006—an additional switch 1006 which can ground to 0V the “pre node” and or node.

FIG. 11 depicts one embodiment of two alternative configurations to interact with a lever 1101 and fulcrum 1100. According to one configuration 1104, the lever and fulcrum has sensors 1102,1104 that are connected by electrical wires 1105 to the sensor grid 100 by connector 1106 where the lever, fulcrum and sensors can also be integrated as one unit. The sensors include a variable resistor 1102 with a tapping point 1103 connecting to the resistor that is used to determine the position of the fulcrum which is recorded on the mobile computing device display along with the force one or both ends of the lever 1104 at any instance. This could be used to teach the effect of level arms and force and instruct about the properties of the simple level machine.

According to a second configuration 1110, the lever and fulcrum has sensors that are connected to multiplexers, ADC, DAC, digital Input/Output and processing unit that are all integrated together in one unit 1110 which in turn can communicate sensor data 1108 to the mobile computing device 116 running a lesson. Physical equipment configured with sensor and connection or communication capabilities for interaction with the mobile computing device running the lesson can be packaged and also sold as one unit.

These are presented as non limiting examples of many ways in which physical systems can be configured with sensor and or output and or electronic 1107 to create units pre assembled to demonstrate a wide variety of experiments, games, monitor and control plants and gardens, eco systems, robots or other systems

For reference with FIG. 11,

1100—fulcrum
1101—lever
1102—variable resistor where the resistance between 1103 and 1111 varies with the movement of the lever relative to the contact with the fulcrum.
1103—electrical tapping contact with the variable resistor.
1104—variable resistance pressure sensor
1105—electrical wires
1106—connector
1107—processing unit, battery, antenna, DAC, ADC, digital I/O and power supply
1108—lower power RF communication of sensor and output values using Bluetooth, Bluetooth low energy, wifi or other protocols.
1109—According to one configuration 1104, the lever and fulcrum has sensors 1102,1104 that are connected by electrical wires 1105 to the sensor grid 100 by connector 1106 where the lever, fulcrum and sensors can also be integrated as one unit
1110—According to a second configuration 1110, the lever and fulcrum has sensors that are connected to multiplexers, ADC, DAC, digital Input/Output and processing unit that are all integrated together in one unit FIG. 12 depicts one embodiment of an example of a game that can be constructed with the system. The user has the challenge to use the handle 1202 to move a loop 1203 along a wire 1201 from beginning 1206 to end 1207 without touching a wire. The wire is connected to a base for stability 1200. If a wire is touched before reaching the end then a light 1204 is turned on as well as optionally a display and or audible buzzer indicating failure to complete the task using the mobile computing device 116. The wire 1201 could be a conductor or have a resistance which would the measurement of the current with the loop 1203 touches the wire 1201 to determine how far along the wire the contact was made and hence progression to completion of the game.

For reference with FIG. 12,

1200—base for holding wire 1201 stable
1201—wire that conducts or has a variable resistance
1202—handle of wire loop with electrical connection between 1203 and 1205.
1203—wire loop conducts electricity and surrounds the wire 1201
1204—led or light globe that turns on when the loop 1203 touches the wire 1201 and closes a circuit between node 102 and node 101
1205—wire connecting 1204 and 1202
1206—Beginning point of the movement of loop 1203 along the wire 1201 by the user
1207—end point of the movement of loop 1203 along the wire 1201 by the user

In one embodiment, questions are posed via a game which the user solves by placement of a component or circuit on the grid to which a correct answer.

In some embodiments, the integrated physical sensor grid lesson system can contain from two to hundreds or thousands of nodes.

In some embodiments, alternative different methods can be used to connect and read and write digital values from nodes to and from the processing unit.

In some embodiments, the grid sensor board 100 can be extended by adding additional boards 100 joined via a slot system where each board has either its own processing units and they are all connected by protocol such as I2C or 1-wire or Bluetooth or Bluetooth low energy or simply be joined by electrical connections without the need for their own processing units.

In one embodiments, multiple sensor grid lesson systems can be connected to one mobile computing device 116 allowing larger circuits to be constructed by combining grids or multiple single sensor grid systems created that can interact together.

In one embodiments, other multiplexer, de-multiplexer, or other switching mechanisms can be used connect the grid connection nodes to the processing unit including directly connecting the processing unit 112 or using protection circuitry such as buffers and drivers or similar where this protection circuitry is designed to be easily replaced in case of damage by students.

In one embodiment, grid sensor and nodes do not need to be on a traditional flat board but could be arrange on machines, such as mechanical cars or robots or other structures.

In one embodiments, various simplifications are possible of the system, involving smaller grid sizes down to as small as only two nodes.

In one embodiments, games of all kinds can be created by users and shared which have a physical component. For example, combined into a memory game where the user has to remember a combination that adds more and more progressive steps in the forms of colors to remember after the user remembers each of the previous steps in order. The game continues until the user makes a mistake remember a previous combination. For example, a four sets of lights and buttons are wire to the grid sensor. Each LED has a resistor placed in parallel with it to limit the current. The light for each set can be made by choosing an LED of a different color. Optionally an enclosure can be created enclosing the button and LED. A program is then made using the configuration language and combined in a lesson which in this case instead of being lesson is instructions on how to wire up the system followed by instructions on the rules of the game and then the user begins the game. The game works under the control of the program configured as part of the grid sensor lesson. The program begins by randomly choosing to display one of the four leds by sending a voltage to the nodes by using the multiplexers to switch the DAC or power supply to the node with the LED and resistor in series. To progress the game, the user must press the button corresponding to the LED. The program switches the multiplexer and power supply which has been set with current limiting to attempt to send a small voltage and current through the nodes connected to the button. When the user presses the button the current will be sensed by the processing unit via the power supply. When the user presses the button and this is sensed then the game moves to the next stage where it now repeats this first step and then displays a new randomly LED and button combination and senses for the user to respond correctly. In this way the game progresses for as long as the user can remember each previous step to get to the next stage. In this way games for all ages as well as for early child hood use can be constructed.

In one embodiment, the grid sensor lesson system can be used to support project based learning. The main idea of project-based learning recognizes that real-world problems capture students' interest and also provoke deep thinking as the students learn and apply new knowledge in a problem-solving context. The grid sensor lesson system allows a student to compose their own lesson content using text, images, video and audio as well as circuits that can be wired up to the processing unit where the user can also define a program that controls, or displays or accepts user input. The pinball machine is one example of project could be assigned to the groups of students potentially as to make where they need to solve the real world problem of making the most playable and engaging pinball machine game. Skills involving Game artwork, science psychology of game design including playability, electronics, programming, project management to collaborate parts made separately on different devices and then combined together, as well as marketing to make promotional content that is visible on the grid sensor lesson uploaded for search by others who are engaged to download it.

Additionally competitions between schools where they compete to complete the same contract can be created. Live results can be uploaded to a website where all users can view them using mobile computing devices 116 or other computers.

In one embodiment, Uploaded lesson can have a promotional page to explain, communicate and otherwise promote the download and usage of the lesson by other users.

In one embodiment, Uploaded lessons can have an associated code to a curriculum course or lesson or teaching unit, for example the Australian national circular. This allows a teacher of student to find grid sensor lessons that correspond to teaching units from a curriculum simply and easily by use of the code to perform a lookup. The creator of the grid lesson plan or subsequent users can assign an associated code. A search can be performed that returns all the courses for a particular curriculum.

In some embodiments, users can search for grid sensor lesson projects stored on a server for different topics by title, author, date, teaching content, and physical components needed as some examples.

In solving real world problems Interdisplinary skills often need to be applied which cannot be support as well through virtual simulations.

Contract based learning can also be supported by this system as the student commit as part of the contract to the delivery of project which must be uploaded to the lesson grid sensor system database optionally along with results so that the delivery can be confirmed as completed.

In one embodiment, a grid sensor lesson comprising of an adder or other such components of a simple computer using the multiplexers or using the GPIO set to digital Input or Output. Begin with showing how to wire up each part that makes up a processor such as simpler building blocks including and, or, nor gates then half adder, adder and memory latches, the student is given a series of smaller components to make using the grid sensor lesson. When the smaller sections is wired and understood then the student is given a next level of lessons replacing the simple building blocks with a whole latch prefabricated in an IC so the student can build up to making a whole computer that interacts by writing output to a display and keyboard on the screen via the a program as part of the lesson plan

In one embodiment, a Turing machine could be described by a grid sensor lesson and then the student guided through the steps to build it. The Turing machine would be constructed by having a motor spinning a cylindrical reel which can move a paper strip back and forward wired to the grid sensor and control by a program in the lesson as well as a lads and light dependent resistors that are allow all wired to the grid sensor and control by a program in the lesson. The user is instructed how to make a program by placing holes on the paper to represent instructions and have the student make a program in the lesson to move the reel back and forward to read instruction by sensing when the light comes thru different combination of sensors and display and receive information on the screen in response to the instructions. As Turing machine are important historical, foundation concept to teach.

In one embodiment simple properties such as the intensity of different color Red, Green, Blue of direct sun light or light reflected off objects or plants could be measure by a system created by users where three light dependent resistor and other circuitry placed on the grid and voltage and current are monitored. If the creator adds lesson instructions other people will be able to create the same circuit if it is shared on the lesson database. The creator can make a program as part of the lesson using the configuration lesson describe as part of the lesson that will show the different combination of three colors so that when the user points the system at different objects as bar graphs of intensities.

An extension experiment would be to see if a user could take the existing integrated lesson and extend it by adding code so that it reads the different levels and can show a symbol corresponding to the different levels of reflected light. The student can be asked to suggest reason why for example the intensity of sunlight is stronger for some and weaker for other components they can input an answer into the results which can be uploaded are results to the database for the teacher to check. For example the student should discover concerning direct sunlight that green is weaker green output, which is of little use to plants.

In one embodiment, simple fun systems can be created by students for example, a cloud detector system could be designed by a student where the light dependent resistor in joined at a with a second resistor with voltage applied. In one embodiment, the lesson can seek to take bring alive historical science experiments so that students understand how the body of scientific knowledge has been built up and can have confidence seeing how with relative simple resources and components using logic and thought problems can be solved. The facility to place lesson material including historical content in the mobile computing device where the lesson also interacts in real time with the user and physical entities on the grid creates a new user experience that can also bring alive content means that may otherwise not engage a student. As one example, Resistive heating was first studied by Joule in 1841 who immersed a length of wire in a fixed mass of water and then measured the temperature rise caused by the known current flowing as set by the experimenter through the wire for a period of 30 minute. Through variation of the current and the length of the wire Joule deduced that the heat produced was proportional to the square of the current multiplied by the electrical resistance of the wire. This is an important scientific principle that can be recreated and taught as a lesson using this system. In a traditional teaching paradigm where teacher creates a lesson that the student follows, then the creator of the lesson introduces the question of how to determine if heat is generated by wire with a current flowing through it and how much heat is produced. It then shows the student how to place a wire between nodes and then how to place a temperature sensor that varies resistance with temperature between two other nodes. The lesson uses the circuit verification profile or code in the lesson sensing inputs to check the wiring is correct. It then instructs the user to immerse the temperature sensor and wire in water and checks with the user if the user has done this. Then it shows the user how to vary current, wait some time and check the temperature of the water and repeat for various currents in order to discover the relationships involved in resistive heat.

In one embodiment, a teacher remote to a user or group of users can through the grid sensor lesson system equipped with an additional live audio and or video link built into the application on the mobile computing device, to interact with the students as they read the lesson pages, build the circuits, review results and vary the design as part of creative play and learning.

Peer users such as the other students in the remote class can also view each other progress and share data and communicate together. In one embodiment, magnetized connectors 101,102,103,104 on the board connector nodes and the wire connecting to nodes can be used. In some embodiments, the connectors 101,102,103,104 may be springs, clips, pins that slip over sheath, loops that wires can be joined to without the need for soldering. The nodes may also be connected through a breadboard of similar wiring systems. In some embodiments, the grid on which the circuit is placed can be transparent and so guide the user by providing a circuit template to follow while constructing the circuit.

In one scenario a game could be created wherein the players must construct a series of physical circuits to solve problems in a game. This is possible because the game measurement system has been created on a mobile computing device 116 which can also display game content providing a novel combination of an intellectual challenge, requiring physical construction, as a video style graphical game.

Another interesting game could be a classic diffuse the virtual bomb. The virtual bomb and counter is shown on the smart device display counting down. A circuit has been wired on matrix. The counter is started and begins counting to 0. Simultaneously the student is shown the circuit and must solve a problem about the circuit in the remaining time. The problem may be to understand which wire in a 555 timer circuit to cut to stop the counter trigger from being set which is being input into the ipad. If the wrong wire cut the trigger would fire and the bomb show a virtual explosion on the screen.

In another example, the student can use electronics and or programming code to create a security system. The user can connect up sensors to the node connectors using electronics and or a programming to for example trigger the ipad to alarm or contact a remote server, send email or test or take a photo when certain sensor triggers occur such as a PIR, beam broke, contact switch open or close accelometer moved or pressure sensor.

The education system is in this way, allowing the student to combine discipline from physics, electronics and programming to solve problems. A far step from traditional kits.

In one embodiment, users such as students could create their own circuits and display on the mobile computing device to construct systems such as machine that can also be shared.

One example would be a pinball game with sensors to detect a ball running over a switch or hitting circular button which the ball will bounce off, holes that sense when the ball can fall through. The flippers could be manually operator by the user without a motor or these could also be controlled via buttons. A physical playing area with circular buttons, switches and a ball as well lights mounted on a board with art work and a stand with an tablet placed as head display at the top of the “pinball machine”. The user could then wire the grid nodes to the switches, buttons and lights. The user could then configure some circuits on the grid which drive or use the sensor values in combination with sending and receiving the values to the software on the smart device where the use can configure actions to perform based on inputs. The user can alternatively use no circuits but have the nodes controlled directly by the user's software instruction configured with the lesson as shown by one example in FIG. 5. The user can alternatively make all or most of the control circuit driven with only minimal or not interfaces to the software. As part of a learning process a teacher could configure a lesson or multiple lessons to try these different combinations for example of all electronic circuits, mixed electronics and all software to achieve the same result. The mixture of creating a fun project which needs to be solve a physical problem with using physical electronic component. The lesson can be arranged so that the use has to not only place physical components on the grid or board but also enter programming code as an input as part of interaction with the lesson to solve problems or complete a task to score points or complete a lesson.

In some embodiments, the nodes may be place on a board as points that can be soldered and where each node can be connected to the system as described. The connection can be made with a connector that can be unplugged when the circuit creation and testing is complete. The board comprising of nodes can be made as a generic design such as a systematical grid of points which can be soldered with teach node 101,102,103,104 wired to the multiplexer 106, 200, 208. Alternatively boards such as PCBs can be created for individualized circuit board with node and wires from the nodes connected to the multiplexers 200,208,106 via a connector. The individualized circuit boards can be adapted from existing designs being identical, but with the addition of the nodes and wires to places on the circuit board where the monitoring is desirable or instructive for a student or user. In this manner, many existing projects can have minor adjustments to their PCB designs and then be usable with the grid sensor lesson system.

In some embodiments, instead of wires coming from each node, each node on the board can be connected to a contact pad. The board can be placed over a pin or wire arrangement that allows the pins to touch the board for a temporary test process. The pins are in turn connected to the multiplexers. This technique is well known to those skilled in the art of in circuit testing.

In some embodiments, the user can choose which node voltages to view using an oscilloscope or multi meter display on the mobile computing device. More than one node can be chosen simultaneously in which case if there are more nodes selected than ADC channels then the multiplexer will switch between the nodes. The oscilloscope and or multi meter settings can be changed at the user's selection. In a similar manner, the user can choose outputs of voltage from a fixed voltage supply or varying supply and waveform and level using DAC.

In some embodiments, the user can choose two or mode nodes that can be connected and simultaneously some combination of ADC and DAC as well as digital Input Output and power supplies applied in order to test a component. In this way the user will be able to view the complete analysis and response of a component on the display of the mobile computing device and be able to interact with the variation of stimuli for measurement as well as view graphs.

In some embodiments, the sensor grid inputs and outputs can be incorporated into a game optionally using game engines such as co cos 2 d. In one example an avatar may have to unlock a reward of access to another area or similar activities by placing one or more of a value resistor(s) between nodes that to match the numerical value in ohms show in the game when the board senses the correct values has been entered the game play is altered and for example a reward is unlocked or other such progress. This example discusses a resistor but the kind of physical interaction could involve magnetism, measurement of force, heat, light as non limiting sensors as well as involving outputs and any other physical component or entity.

In another embodiment, the user may make robot using the grid sensor board to construct the circuits and software, he can then upload i system shop where art work is generated for Printed Circuit Board (PCB), pcb is manufacture and offered for free or sale. The software he created can also be uploaded for use by others, The creator may also be able to receive a royality for his creation. Where there is addition manufactured or printed printing of paper, plastic stickers, or manufacture of enclosures or parts of the machine or system then these can also be uploaded for sharing and printed, or manufactured for example using 3 d printing. Where a project is popular this may be done automatically for most voted or popular. In this way create an incentive for creation through knowledge design will be shared. Regular completion could also be run. In some embodiments, as an alternative to Bluetooth or Bluetooth low energy, USB, i2C, 1-wire and other communicated can be used to communicate with a mobile computing device or any other computing device with the software installed.

In some embodiments, A lesson creator May also be able to advertise a course that can be created sold or given by a presenter. In one embodiment, a lesson may comprise of just a circuit diagram which monitors for correct assembly. In some embodiments, the lesson may allow entry of code by the user into display pages during the running of the lesson in order to complete answers or make a system work to finish the task or question set by the lesson. This code will be interpreted and run in a similar fashion to the lesson code itself and be of a similar range of formats specified. In a similar way in addition to code, other techniques such as creation of graphics symbols connected to symbols as well as the definition of user interface components that control output onto the sensor grid can be defined. In this way to seamless experience of viewing teaching content and simultaneously interacting with physical world without the need to uploaded and program the device or have knowledge of skills to do this is avoided.

In some embodiments, the API as well as a language interrupter used to support the creation of the content, code and logic that interacts with the grid sensor electronics including the grid sensor board 100, multiplexers 106,107,200,208 and processing unit 112 and all associated components can be javascript, python, basic, and all such similar languages or a combination as well as graphically orientated methods for defining graphical symbols and action associated with each sensor value to cause the display of different symbol states, images, coloring, filling levels as well as audio able outputs. The language or graphical symbol definition configuration methods used to support the creation of the content and logic should also provide the user with the ability to compute logic optionally using sensor inputs and or user interface selection to drive outputs supplied to components on the grid sensor.

In one embodiment the systems the API as well as a language interrupter used to support the creation of the content that interacts with the grid sensor electronics including the grid sensor board 100, multiplexers 106,107,200,208 and processing unit 112 and all associated components, can be provided in a form, such as a library, dll or other similar form that can be incorporated into other Apps, for example as can be created and hosted on the Apple App Store or Android applications. The API allows reading, writing to the grid sensor and connectors as well as switching the multiplexers and GPIO.

In one embodiment, grid sensors lessons stored in the database can be associated with suppliers of the physical components including the grid broad needed for the lesson through advertising or as sponsors, recommended suppliers, or as creators of the lesson. Sales of components can be made through the server from where the lessons are hosted. Where physical objects are also need for lessons, for example 3D plans including 3D printer plans can be purchased or the created objects. For example, a lesson describing gears and levers as machines to be studied, may need to have gears and levers which are instrumented by the sensors, the 3 d plans or 3D object itself can be sold through a website store separately or as part of the kit. Many suppliers may display competing kits. The system may have inbuilt checking to ensure that content run from on the device has been downloaded only from a known server such as the server storing grid sensor profiles.

In some embodiments, the grid sensor system can be used to allow a lesson to interact with systems used in a garden measuring moisture, sunlight with sensors as well as driving outputs for watering.

In some embodiments, the grid sensor system can be used to allow a lesson to interact with systems used to measure all manners of physical conditions which can be measure as non limiting examples, Switches, forces, accelerometers, temperature, pressure, light. As a well as output as a non limiting example to display LEDs, motors, speakers, heaters.

In some embodiments, The sensors can either connected directly to nodes and measured or controlled using the DAC, ADC, digital I/O, power supplies. In some embodiments, the digital Inputs and outputs including through the GPIO can be used to support functionality similar to a logic analyzer. In some embodiments, the ADC can be used to support functionality similar to an oscilloscope. In some embodiments, the DAC can be used to support functionality similar to an function generator. In some embodiments, a student can also contact teachers or technical assistance through the system such as by selection from a remote server to help to analyze the circuit or results. The assistant may be able to remotely view the grid sensor system values and drive outputs to perform remote analysis and investigation. In some embodiments, grid sensor lesson may be used to assist in following the steps focusing on the construction of the project. The sensor of the grid allows progress to be monitored and corrected. Where a problem cannot be solved, a server can allow other users to assist the user experiencing problems by allowing them remote access to the sensor data and output. The assistance can be free or paid for and accessible from a server and or database 131.

Embodiments of the integrated physical sensor grid and lesson system include various advantages. Some embodiments combine textbooks and or website content with processor programming in seamless easy to use way which does not require understanding and tools to do separately downloading required by present solutions. Ease of use is a big issues for teachers wishing to extend classroom education where they do not have the skills in electronics and embedded programming. In some embodiments, a living textbook where the content interacts with sensor and output values and systems are controlled and/or observed by the user. The content behaves in a variety of different ways depending on the sensors and outputs. This creates a rich interactive experience customizable to interact with all systems that may be measured by available sensors or outputs that can be connected to the grid. In some embodiments, the problem of lack of teacher or parent skills to assist students is reduced or removed entirely by the lesson providing interactive support to the student. In some embodiments, the system fosters creativity and sharing by providing a common framework to share projects and the content that goes with it that is simple and provides all the elements needed including physical components. The user can share results with community or class of teacher.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

An embodiment of a integrated physical sensor grid and lesson system includes at least one processor coupled directly or indirectly to memory elements through a system bus such as a data, address, and/or control bus. The memory elements can include local memory employed during actual execution of the program code, bulk storage, and cache memories which provide temporary storage of at least some program code in order to reduce the number of times code must be retrieved from bulk storage during execution.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, including an operation to monitor a pointer movement in a web page. The web page displays one or more content feeds. In one embodiment, operations to report the pointer movement in response to the pointer movement comprising an interaction gesture are included in the computer program product. In a further embodiment, operations are included in the computer program product for tabulating a quantity of one or more types of interaction with one or more content feeds displayed by the web page.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Embodiments of the invention can take the form of an entirely hardware embodiment, an entirely software embodiment, or an embodiment containing both hardware and software elements. In one embodiment, the invention is implemented in software, which includes but is not limited to firmware, resident software, microcode, etc.

Furthermore, embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Input/output or I/O devices (including but not limited to keyboards, displays, pointing devices, etc.) can be coupled to the system either directly or through intervening I/O controllers. Additionally, network adapters also may be coupled to the system to enable the data processing system to become coupled to other data processing systems or remote printers or storage devices through intervening private or public networks. Modems, cable modems, and Ethernet cards are just a few of the currently available types of network adapters.

What is claimed is:

1. An instruction verification system, the system comprising:
a plurality of nodes;
a processor, wherein said processor is electrically connected to said plurality of nodes, wherein said processor is disposed to measure electrical signals from said plurality of nodes;
a radio communication link;
a mobile computing device, wherein instructions are displayed, wherein said measured electrical signals are received from said processor using said radio communication link, and whereby a report is communicated to the user in response to the comparison of said measured electrical signals against expected results.

2. The instruction verification system of claim 1, wherein said mobile computing device or said processor executes a circuit verification profile to check said measured electrical signals from said plurality of nodes are correct.

3. The instruction verification system of claim 1, wherein said mobile computing device first displays said content, instructions or questions and then executes a circuit verification profile to check said measured electrical signals from said plurality of nodes are correct.

4. The instruction verification system of claim 1, wherein said report consist of the display of a message to user communicating the successful completion of said displayed instruction, question or response to content.

5. The instruction verification system of claim 1, wherein said content consists of game play content or teaching material.

6. The instruction verification system of claim 1, wherein said report consist of the assignment of points, rewards or progress within a game.

7. The instruction verification system of claim 1, where said report include messages indicating a correct answer, measured values, suggestions, instructions, progress indicators, graphs or other forms of graphical presentations.

8. The instruction verification system of claim 1, wherein a plurality of said nodes may be connected to a processor using a multiplexer.

9. The instruction verification system of claim 1, wherein at least one node has an electrical signal output to said node according to execution of said circuit verification profile.

10. The instruction verification system of claim 1, wherein at least two nodes have at least one sensor connected to said nodes to measure physical characteristics such as temperature, pressure, light, magnetism, sound, force, acceleration, velocity, moisture, ultraviolet radiation, electrical voltage, electrical current, electrical resistance or weight.

11. The instruction verification system of claim 1, wherein said communications link is a bluetooth low energy connection or bluetooth smart connection.

12. The instruction verification system of claim 1, wherein said nodes are magnetized to allow electrical connectors to be affixed to said nodes.

13. The instruction verification system of claim 1, further including database of grid sensor lesson, wherein users can create, upload or download or in otherwise share said grid sensor lessons, instructions or circuit verification profiles.

14. The instruction verification system of claim 1, further including a database of results including video of the execution of grid sensor lessons recorded by said mobile computing device or sensor measurement values.

15. The instruction verification system of claim 1, wherein said plurality of nodes is mounted on a board, structure or a printed circuit board.

16. The instruction verification system of claim 1, wherein said processor employs an analogue to digital converter to measure electrical signals from said plurality of nodes.

17. A method of instruction verification comprising
a. displaying content or instructions directing the arrangement of physical components,
b. verification by a processor executing a circuit verification profile that a plurality of node measurements correspond to a correct arrangement of physical components,
c. reporting said verification by a mobile computing device connected to said processor by a low energy communication link, wherein a user may receive verification of the correct adherence to said content or instructions, whereby said user may progress their understanding of said content or instructions.

18. An integrated physical sensor grid system, the system comprising:
a grid sensor board, wherein the grid sensor board comprises one or more electrical contacts, wherein the grid sensor board comprises one or more sensors to detect electrical properties at each electrical contact;
a processor coupled to the grid sensor board;
a computing device coupled to the grid sensor board, wherein the computing device is configured to display instructions to a user, wherein the instructions are part of a lesson plan, wherein the processor compares readings of the one or more sensors against expected progress indicated in the lesson plan, wherein the expected progress is outlined by verification codes, and wherein the computing device is configured to display results to the user in response to the comparison of readings against expected progress.

19. The integrated physical sensor grid system of claim 18, wherein the lesson plan is shared on a searchable site, wherein the lesson plan is rated.

20. The integrated physical sensor grid system of claim 18, the system further comprising a configuration constructed on the grid sensor board, wherein the configuration is a circuit, and wherein the lesson plan comprises a circuit diagram.
